(19) United States
(12) Patent Application Publication
(10) Pub. No.: US 2002/0194301 A1
(43) Pub. Date: Dec. 19, 2002

(54) Information distribution system

(76) Inventors: Hiroki Morii, Chiba (JP); Kiyosato Izawa, Ibaraki (JP); Keigo Ohsaki, Tokyo (JP)

Correspondence Address: William S Frommer, Frommer Lawrence & Haug, 745 Fifth Avenue, New York, NY, 10151, US

(21) Appl. No.: 10/169,385

(22) PCT Filed: Nov. 1, 2001
(86) PCT No.: PCT/JP01/09602

(30) Foreign Application Priority Data
Nov. 1, 2000 (JP) 2000-373562

(51) Int. Cl. G06F 15/16

(52) U.S. Cl. 709/217; 709/203

(57) ABSTRACT

Program information is distributed to many user terminals with ease.

After channel table data CHDAT and timetable data TMDAT are distributed to user terminals 6A, 6B . . . via a transmission line 4 under the control of a program control server 3, frame-contents-of-program data Dmnp composing timetable data TMDAT is specified with the user terminals 6A, 6B . . . , and thereby the above frame-contents-of-program data Dmnp is distributed to the user terminals 6A, 6B . . . . As a result, an information distribution system capable of simultaneously distribute program information having the same contents to many user terminals 6A, 6B . . . can be constructed.

### TECHNICAL FIELD

The present invention relates to an information distribution system, and more particularly, is suitably applied to a case of distributing information via an information transmission network such as the Internet.

### BACKGROUND ART

Conventionally, in order to provide home page information of via the Internet, a home page is created on a WWW (World Wide Web) server in the Internet.

As an information distribution server for hypertext multimedia data, the world wide web (WWW) server stores server software called HTTP (HyperText Transfer Protocol) and hypertext information in a description language called HTML (HyperText Markup Language), so as to establish a linkage to information in its own database or another database with information address data called URL (Unifome Resource Locator) included in link information called an anchor.

In a conventional world wide web (WWW) server, various kinds of information can be taken from the world wide web (WWW) server or another world wide web (WWW) server via the Internet into an internet user terminal based on information address data (URL data) which is included in a home page as link information. However, there is an inconvenience problem in that the WWW server is not arranged to allow many internet user terminals to simultaneously (at the same time) obtain mass home page information or information of which the contents change with time, such as motion picture.

The present invention has been made considering the above point and is proposing an information distribution system in that even mass information or information which changes with time can be simultaneously distributed to many user terminals.

### DESCRIPTION OF THE INVENTION

To obviate such problems, the present invention provides an information distribution system 1 for distributing program information data INF stored in a database 2A of a program distribution server 2 to many user terminals 6A, 6B . . . via an information transmission network 5 under the control of a program control server 3. The program information data INF stored in the database is composed of a plurality of unit program data DM-N obtained by dividing program information of each channel CH1-CH4 on a first split time basis, and each of unit program data DM-N is composed of a series of frame-contents-of-program data Dmnp obtained by subdividing program information data INF for each first split time on a second split time basis, and the program control server 3 distributes channel table data CHDAT for specifying unit program data DM-N, and timetable data TMDAT for specifying frame-contents-of-program data Dmnp as a part of the channel table data CHDAT, to the user terminals 6A, 6B . . . , and when specification information specifying one data in the channel table data CHDAT is entered in one or plural user terminals 6A, 6B . . . , timetable data TMDAT corresponding to the channel table data CHDAT specified through input is given from the user terminals to the program distribution server 2, so that the corresponding frame-contents-of-program data Dmnp is distributed from the program distribution server 2 to the user terminals 6A, 6B . . . in that the specification information has been entered, via the information transmission network 5.

Further, in an information distribution system 1X for distributing program specification information data INF stored in a database 2XA of a main program distribution server 2X to plural additional distribution servers 2A, 2B . . . 2E via an information transmission network 5 under the control of a program control server 3 and then distributing the above distributed program information data INF from the plural additional distribution servers 2a, 2B . . . 2E to corresponding one or plural user terminals (6AA, 6AB, 6AC), (6BA, 6BB, 6BC) . . . (6EA, 6EB, 6EC), the program information data INF stored in the database XA is composed of a plurality of unit program data DM-N into which program information of each of one or plural channels is divided on a first split time basis, and each of unit program data DM-N is composed of a series of frame-contents-of-program data obtained by subdividing program information data INF for the first split time on a second split time basis, the program control server distributes the program information data Dmnp in the main program distribution server 2X to the plural additional distribution servers 2A, 2B . . . 2E, the program control server distributes channel table data CHDAT for specifying unit program data DM-N, and timetable TMDAT for specifying the frame-contents-of-program data Dmnp as a part of the channel table data CHDAT, to the user terminals (6AA, 6AB, 6AC), (6BA, 6BB, 6BC), (6EA, 6EB, 6EC), and when specification information specifying one data in the channel table data CHDAT is entered in one or plural user terminals, the program control server makes the additional distribution servers 2A, 2B, 2E to which the user terminals belong, distribute the frame-contents-of-program data Dmnp of the unit program data to the user terminals in that the specification information has been entered, via the information transmission network 5 based on the timetable data TMDAT included in the channel table data CHDAT specified through input.

Thereby, an information distribution system capable of simultaneously distributing program information having the same contents to many user terminals (6AA, 6AB, 6AC), (6BA, 6BB, 6BC), (6EA, 6EB, 6EC) can be constructed.

### BRIEF DESCRIPTION OF DRAWINGS

FIG. 1 is a system view showing an information distribution system of a first embodiment according to the present invention.

FIG. 2 is a schematic diagram showing the structure of distribution information INF to be distributed in the information distribution system of FIG. 1.

FIG. 3 is a schematic diagram explaining unit program data DM-N and frame-contents-of-program data Dmnp which compose the distribution information INF of FIG. 2.

FIG. 4 is a table illustrating channel table data CHDAT for specifying unit program data DM-N of FIG. 3.

FIG. 5 is a table illustrating timetable data TMDAT included in the channel table data CHDAT of FIG. 4.

FIG. 6 is a schematic diagram explaining a method of transmitting program information.

FIG. 7 is a schematic diagram showing a program select switch SW1 displayed on the display of a user terminal.

FIG. 8 is a schematic diagram showing a display return switch SW2.

FIG. 9 is a schematic diagram showing a reservation program select switch SW3.

FIG. 10 is a schematic diagram explaining information to be used to specify frame information.

FIG. 11 is a schematic diagram showing an example of commercial picture DPI.

FIG. 12 is a schematic diagram showing the display screen of a user terminal to explain a method of storing a commercial picture.

FIG. 13 is a schematic diagram showing a bookmark list screen provided on the display screen of a user terminal.

FIG. 14 is a schematic diagram explaining a method of distributing program information data from program distribution servers to user terminals.

FIG. 15 is a schematic diagram showing another distribution method different from that of FIG. 14.

FIG. 16 is a table illustrating another example of timetable data.

FIG. 17 is a timing chart explaining a distribution method of high-resolution motion picture data.

FIG. 18 is a timing chart explaining a dispersed distribution method.

FIG. 19 is a block diagram showing an information distribution system of a second embodiment.

FIG. 20 is tables illustrating timetable data TMDAT to be used in the information distribution system of FIG. 19.

FIG. 21 is a block diagram showing an information distribution system of a third embodiment.

FIG. 22 is a block diagram showing an information distribution system of a fifth embodiment.

FIG. 23 is a block diagram showing the construction of a user terminal.

FIG. 24 is a schematic diagram showing a flow of data which is communicated between user terminals 6A, 6B, . . . , and a program control server 3 or a program distribution server 2.

FIG. 25 is a flowchart showing a program startup processing procedure RT0 of the CPU 31 of FIG. 23.

FIG. 26 is a schematic diagram showing a control panel display procedure DIP1 of a display 38 of FIG. 23.

FIG. 27 is a flowchart showing an X-channel button processing procedure RT1 of the CPU 31.

FIG. 28 is a schematic diagram showing a program display panel DIP2 of the display 38.

FIG. 29 is schematic diagrams explaining divided motion picture data.

FIG. 30 is schematic diagrams explaining motion-picture middle-reproduction processing.

FIG. 31 is a flowchart showing a picture information reading processing procedure RT2 of the CPU 31.

FIG. 32 is a flowchart showing a normal-reproduction-display interruption-timer processing procedure RT3 carried out by CPU 31.

FIG. 33 is a flowchart showing a motion-picture normal-reproduction-display interruption-timer processing procedure RT4 carried out by the CPU 31.

FIG. 34 is a flowchart showing a motion-picture middle-reproduction-display interruption-timer processing procedure RT5 carried out by the CPU 31.

FIG. 35 is a schematic diagram showing another example of a display screen.

FIG. 36 is a schematic diagram showing another example of a display screen.

### BEST MODE FOR CARRYING OUT THE INVENTION

An embodiment of the present invention will be described in detail with reference to the accompanying drawings.

(1) First Embodiment

(1-1) Whole Construction

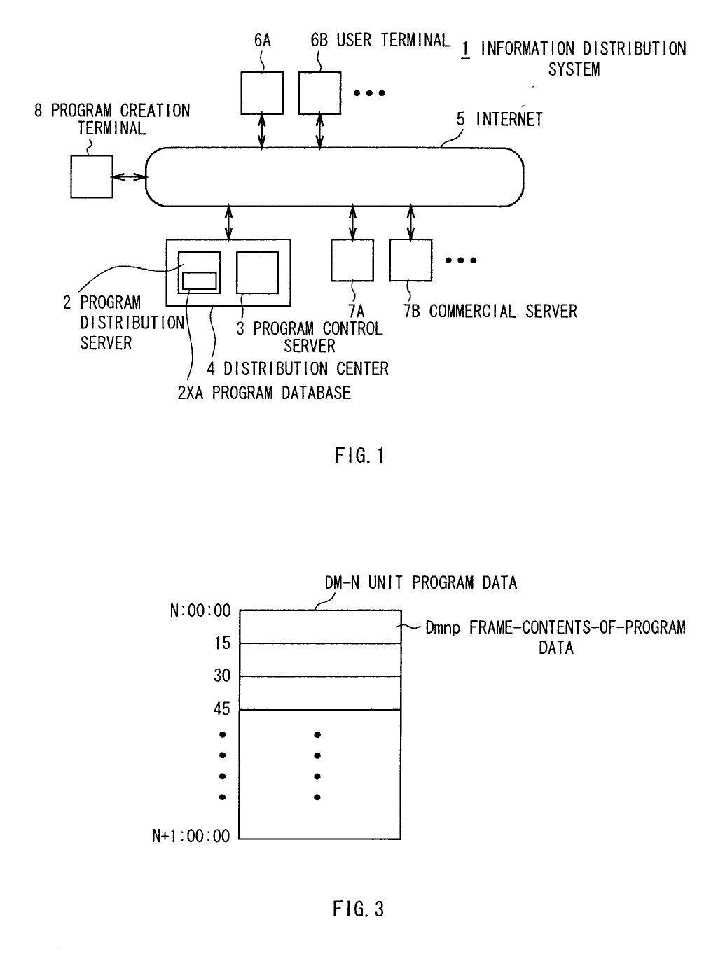

Referring to FIG. 1, reference numeral 1 shows an information distribution system as a whole, in which a distribution center 4 having a program distribution server 2 and a program control server 3 is connected to the Internet 5 serving as an information transmission network.

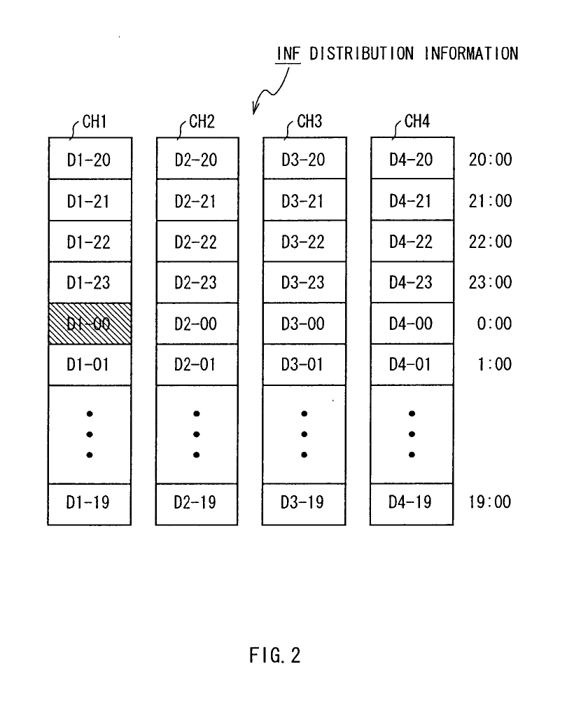

As shown in FIG. 2, the program distribution server 2 stores unit program data (D1-20, D1-21 . . . D1-19), (D2-20, D2-21 . . . D2-19), (D3-20, D3-21 . . . D3-19) and (D4-20, D4-21 . . . D4-19) obtained by dividing program information for plural channels, the first, the second, the third and the fourth channels CH1, CH2, CH3 and CH4, on a first split time (in this case, one hour) basis, in a program database 2XA as distribution information INF.

This distribution information is created by a program creation terminal 8 connected to the Internet 5 and is stored in the program database 2XA.

In the case of this embodiment, the program information of the first to the fourth channels CH1 to CH4 is composed of unit program data D1-20 to D4-20, D1-21 to D4-21 . . . D1-19 to D4-19 (these are represented by DM-N:M=1 to 4, N=20 to 19), these data starting at 20:00, 21:00 . . . 19:00 (these are represented by “20:00”, “21:00”. . . “19:00”).

As shown in FIG. 3, each of unit program data DM-N is composed of a plurality of frame-contents-of-program data Dmnp between N:00:00 and N+1:00:00, each for second split time: in this case, 15 seconds.

Each of unit program data Dmnp corresponds to one picture of a home page. Thus, the unit program data DM-N has the frame-contents-of-program data Dmnp that corresponds to 4×60 pictures of home pages, one picture every second split time (that is, fifteen seconds), within the first split time being one hour (that is, between N:00:00 and N+1:00:00 (N=20 to 19)).

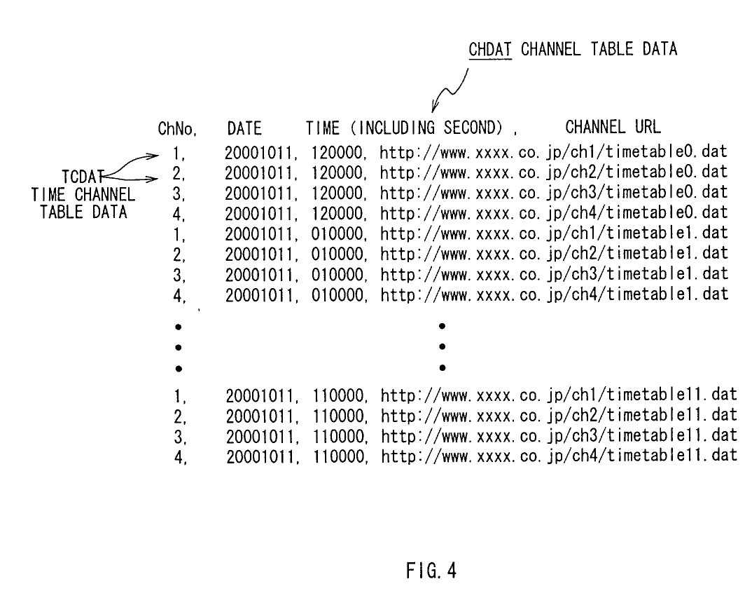

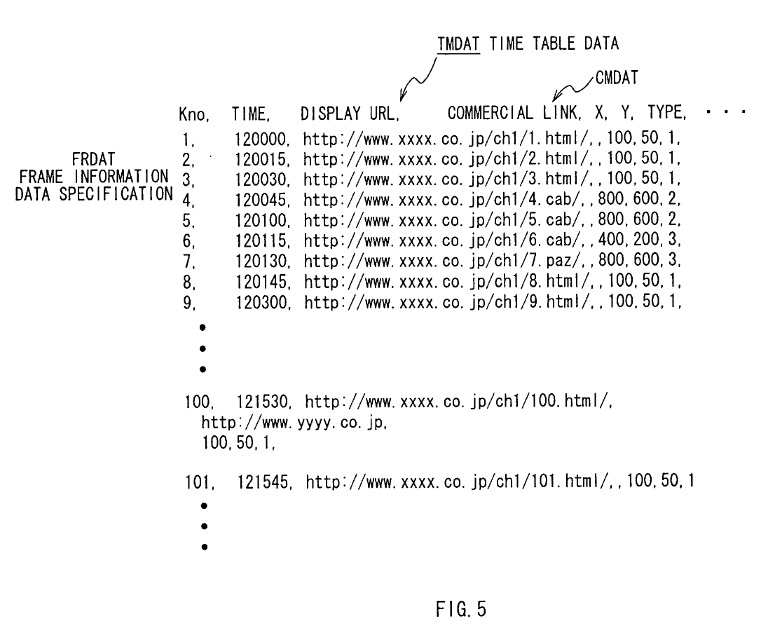

The frame-contents-of-program data Dmnp is specified by user terminals 6A, 6B . . . via the Internet 3 (FIG. 1) with channel table data CHDAT of FIG. 4 and timetable data TMDAT of FIG. 5.

The channel table data CHDAT has such a data structure that time channel table data TCDAT each having “channel number data” (ChNo.) specifying a channel number on which the program information is distributed (in this embodiment, the first to the fourth channels), “date data” (date) representing date of distributing the program, “time data” (time (including second)) representing time of distributing the program, and “channel address data” (channel URL: Uniform Resource Locator) representing the location where the program information is stored, are arranged in a temporal order.

In the channel table data CHDAT of FIG. 4, data on the first line has “channel number data” of “1” (representing that the first channel is specified), “date data” of “20001011” (representing that Oct. 11, 2000 is specified), the “time data” of “120000” (representing that 12:00:00 is specified), and the “channel information address data” of “http://www.xxx.co.jp/ch1/timetable.dat” (representing that the location of the program is in the timetable of the first channel “ch1/timetable.dat” of “http://www.xxxx.co.jp” server, that is, a program distribution server 2).

Therefore, the user terminal 6A, 6B . . . transmits the data on the first line of the channel table data CHDAT of FIG. 4 to the Internet 5, so as to reserve the reception of the program information on the first channel from the server having the server number “http://www.xxxx.co.jp” (that is, program distribution server 2) for one hour from 12:00:00, Oct. 11, 2000, based on the specification by the timetable data “timetable.dat”.

Also data on the other lines in the channel table data CHDAT of FIG. 4 are the same as above.

In the channel table data CHDAT of FIG. 4, each of the timetable data “timetable.dat” included in the “channel information address data” has timetable data TMDAT having a structure shown in FIG. 5.

The timetable data TMDAT has frame information specification data FRDAT to specify frame information to be sequentially displayed every second split time (15 seconds), within the first split time (one hour), as the data on respective lines.

Each of the frame information specification data FRDAT on the first, the second, . . . lines includes “frame number data” (Kno: (“1,”, “2” . . . ) representing the frame number within one hour, “frame display time data” (time “12000”, “120015” . . . ) representing time of displaying the frame information, “frame information address data” (display URL “http://www.xxxx.co.jp/1./”, “http://www.xxxx.co.jp/ch1/2./”. . . ) representing the location of the frame information (including the frame information of program pictures and the frame information of commercial pictures), “picture format data” (“html”, “cab”, “paz”) representing the picture creation format of the frame information, “commercial link specification data” CMDAT (“,,”) representing a commercial server which stores commercials for watching commercial pictures after a program finishes, “display width specification data” (“100, 50”, “100, 50,”. . . ) representing the number of display dots of the frame in the X-direction and the Y-direction, and “display type specification data” representing the type of display picture (in the case of this embodiment, “1,” means a normal picture, “2,” means a created picture (an animation, for example), and “3,” means a motion picture with sounds).

The picture format data “html” means HTML (HyperText Markup Language: a picture is created by a hypertext standard language protocol (a picture not subject to special picture processing)). The “paz” means that a picture is created by a motion picture division technique, and the “cab” means that a picture is created by a picture compression technique (for example, MPEG: Moving Picture Experts Group (International standards for media motion picture compression technique).

Referring to FIG. 5, for instance, the frame information specification data FRDAT on the first line has “1” as frame number data (representing being the first frame), “120000,” as frame distribution time data (representing that distribution starts at 12:00:00), “http://www.xxxx.co.jp/ch1/1.html/” as frame information address data (in this embodiment, representing that a normal picture on the first channel “CH1” in the program distribution server 2 which has the server specification number is specified (there are two cases: a program frame picture and a commercial frame picture), (,,) as commercial specification link data which is used in the case where the frame is a commercial (representing that this frame does not make a commercial server link because there is no data between commas), “100, 50,” as display width specification data (representing that the display width has 100 dots in X-direction and 50 dots in Y-direction), and “1,” as display type specification data (representing that the frame is displayed in the first display format, that is, as a normal picture).

Also frame information specification data FRDAT on the other lines in the timetable data TMDAT of FIG. 5 are the same as above.

In the case where the frame picture is a commercial and therefore there is commercial link specification data, the user terminals 6A, 6B . . . previously store the commercial link specification data when receiving a program. Thereby, after the program information finishes, the user terminals 6A, 6B . . . can obtain the same picture display information as a commercial picture that was used as a part of the program information, from commercial servers 7A, 7B . . . (FIG. 1) based on the commercial link specification data.

The hundredth frame of the timetable data TMDAT of FIG. 5 is a commercial display picture, and it shows that its frame number data is “100,” and its frame display time data is “121530,” (representing 12:15:30), and it has the commercial display picture information of “ch1/100.html” in the program distribution server 2 having the server number “http://www.xxxx.co.jp/”, this commercial display picture can be obtained from a commercial server 7A, 7B . . . (FIG. 1) having the server number “http://www.yyyy.co.jp/” when the program finishes, and this picture is displayed in the size specified by the display width specification data “10, 50,” and in a format specified by the display type specification data “1,” (normal picture).

Therefore, in the case of FIG. 5, the commercial display picture can be distributed to the user terminals 6A, 6B . . . for 15 seconds from 12:15:30 between the program pictures.

(1-2) Distribution of Program Information

In the information distribution system 1 of FIG. 1, the distribution center 4 previously distributes control information including standard time information, to the user terminals 6A, 6B . . . that will receive the distribution of program information. As a result, the plural user terminals 6A, 6B . . . simultaneously receive the distribution of the same program information based on this standard time information.

(1-2-1) Distribution of Control Information

A user terminal 6A, 6B . . . stores a distribution program (this is called “active view program”) when it registers in the information distribution system 1, and starts up the active view program at the time of receiving program information from the distribution center 4.

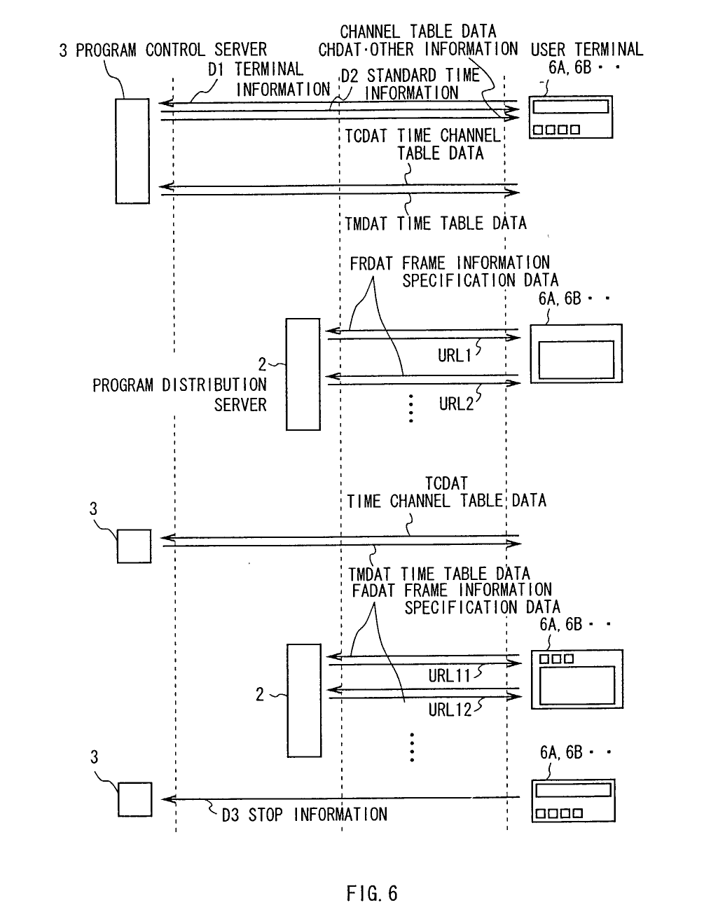

At this time, as shown in FIG. 6, the user terminal 6A, 6B . . . transmit terminal information D1 including a terminal ID, personal information, to the program control server 3 of the distribution center 4. In response to this, the program control server 3 transmits standard time information to the user terminal 6A, 6B . . . .

As a result, the user terminal 6A, 6B . . . which has received the standard time information D2 set time so as to match with the program control server 3. Thereby, plural user terminals 6A, 6B . . . subject to the time matching can independently operate in synchronization with the distribution center 4 based on the standard time.

In this condition, the user terminal 6A, 6B . . . receives the distribution of channel table data CHDAT (FIG. 4) for all the program data included in the distribution information of FIG. 2, and stores this.

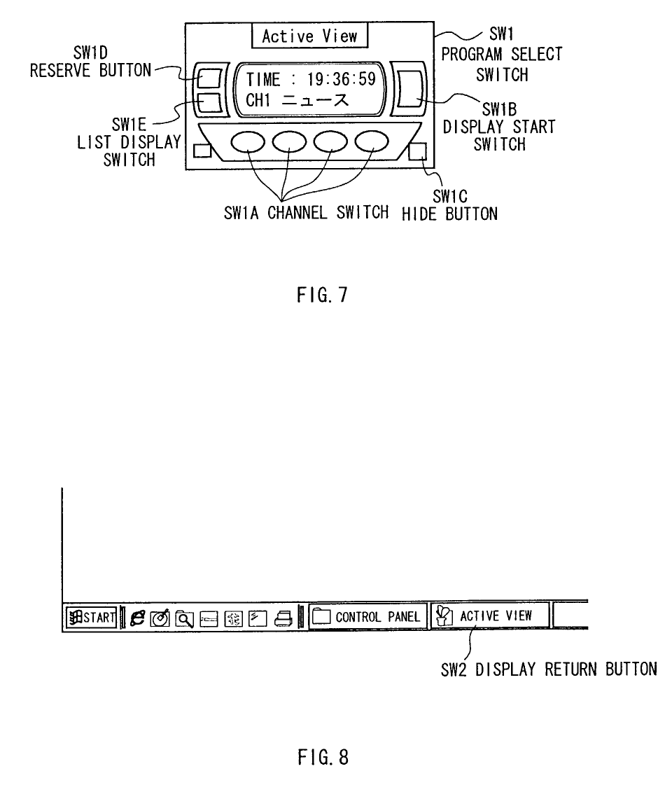

Thus, the user terminal 6A, 6B . . . can specify unit program data DM-N (FIG. 3) of any time on the first through the fourth channels stored in the program distribution server 2 (that is, from 20:00 to 19:00). In this condition, a program select switch SW1 shown in FIG. 7 is displayed on the display of the user terminal 6A, 6B . . . , and the present time is displayed in a “TIME” field (“19:36:59”, displayed based on the standard time). Also, with first to fourth channel switches SW1A, a user can specify a desired channel to receive distribution at the present time (the display of specified contents “CH1 NEWS” appears).

Under this condition, when a display start switch SW1B is operated, a window is opened on the display to display the picture of the distribution information.

The display of this program select switch SW1 is disappeared from the display by operating a hide button SW1C, and it can be returned by operating a display return button SW2 provided in a task bar as shown in FIG. 8.

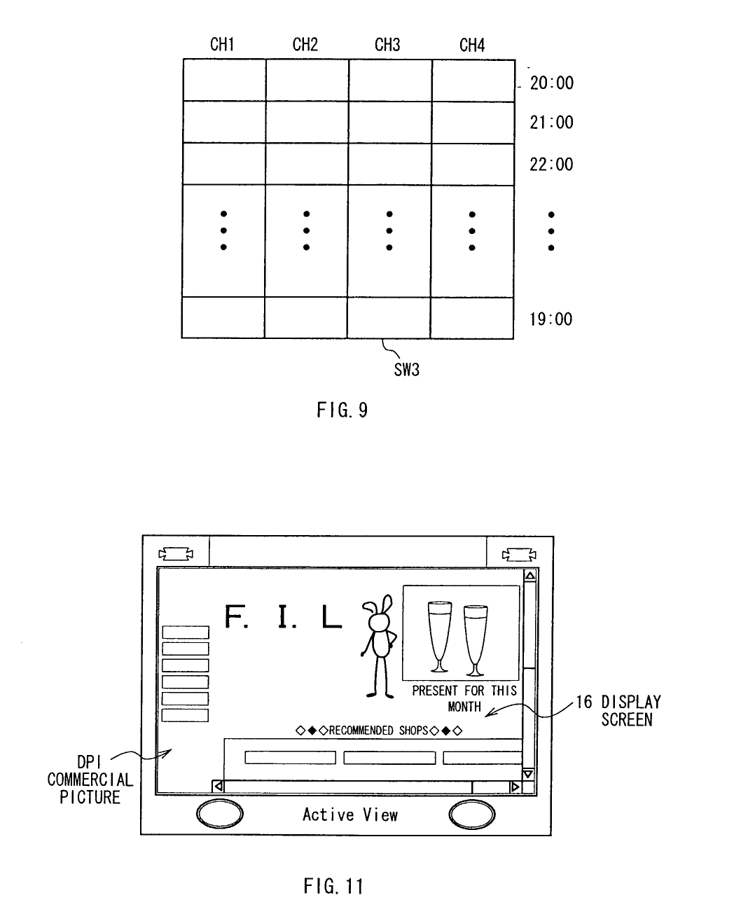

In the case of this embodiment, a reserve button SW1D is provided in the program select switch SW1. When this button is operated, program select switches SW3 arranged corresponding to the unit program data DM-N of FIG. 2 are displayed on the display of the user terminal 6A, 6B . . . as shown in FIG. 9, so that the user can specify and reserve a desired program (that is, a program to be distributed on the first-fourth channel between 20:00 and 19:00 by the program distribution server 2) by operating one of the switches.

(1-2-2) Distribution of Program Information

When the user wants to receive a desired program with the user terminal 6A, 6B . . . , the user operates the channel switch SW1A in the program select switch SW1 on the display of the user terminal 6A, 6B . . . .

When the display start switch SW1B of the user terminal 6A, 6B . . . is operated in this condition, the program distribution server 2 sequentially returns the frame information specification data FMDAT of the distributed timetable data TMDAT to the user terminal 6A, 6B . . . .

Thus, the frame pictures displayed by the frame display data are sequentially displayed on the display of the user terminal 6A, 6B . . . .

Assuming that the user has specified the program of “12:00:00, Oct. 11, 2000 ” on the “first” channel as distribution request information, the user terminal 6A, 6B . . . transmits the time channel table data TCDAT on the first line of FIG. 4 to the program control server 3 (FIG. 6) and thereby receives the distribution of corresponding timetable data TMDAT (FIG. 5), and transmits the frame information specification data FRDAT to the program distribution server 2 line by line every time when frame distribution time comes (FIG. 6).

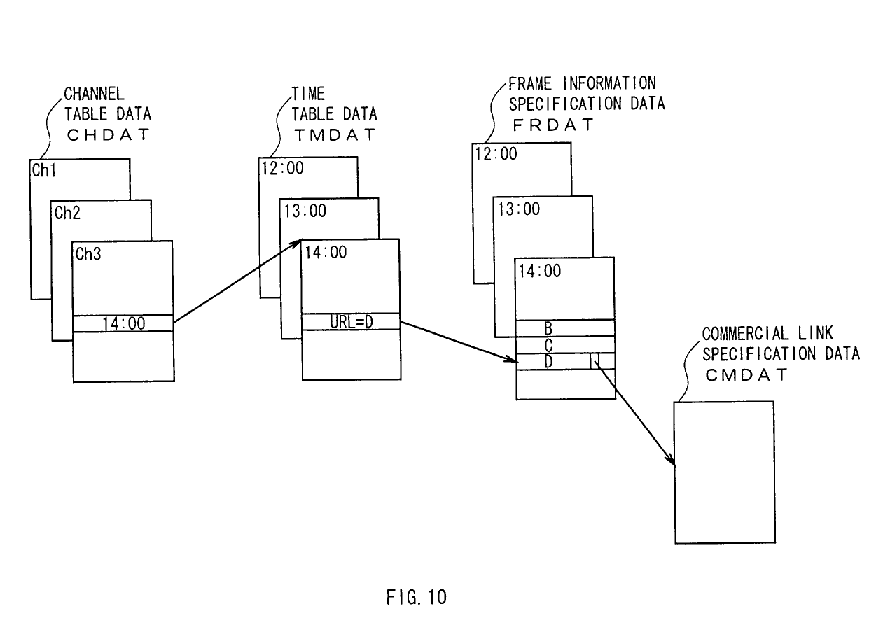

In this manner, as shown in FIG. 10, the user terminal 6A, 6B . . . specifies the program control server 3 based on channel information specification data included in the channel table data CHDAT which is distributed from the program control server 3, in order to receive the distribution of the timetable data TMDAT, and thus receiving the distribution of the frame picture data, commercial picture data and commercial link specification data CMDAT from the program distribution server 2 as picture information URL1, URL2, . . . , based on the frame information specification data FRDAT included in the timetable data TMDAT (FIG. 6).

If the timetable data TMDAT does not have commercial link specification data CMDAT (that is, it has “,,”), the user terminal 6A, 6B . . . receives the distribution of picture data that is not a commercial, from the program distribution server 2.

On the contrary, when receiving display data including commercial link specification data CMDAT as timetable data TMDAT, the user terminal 6A, 6B . . . displays the commercial picture on the display based on the commercial display data, and stores the commercial link specification data CMDAT. Thereby, after the program finishes, the user terminal 6A, 6B . . . can obtain the commercial information from a specified commercial server 7A, 7B . . . via the Internet 5.

Referring to FIG. 5, the frame information specification data FRDAT with the frame program Kno of “100” specifies the commercial server 7A, 7B of “, http://www.yyyy.co.jp,” as commercial link specification data CMDAT.

As described above, the program information specified by the user with the program select switch SW1 (FIG. 7) can be displayed on the display of the user terminal 6A, 6B . . . so as to be sequentially switched every 15 seconds during a time period specified by the frame display time data of the timetable data TMDAT.

Thus, the user can watch pictures (composed of program pictures and commercial pictures (as shown in FIG. 11, for example) inserted therebetween) that sequentially change every 15 seconds, which allows the user to receive pictures having a larger amount of information via the Internet 5.

In this case, as shown in FIG. 11, a commercial picture DP1 to be displayed on the entire display screen of the user terminals 6A, 6B . . . can be received as one of the pictures that change every 15 seconds. Thereby, the user can read the commercial contents (for example, detailed information on items that the user wants to buy) without missing.

Furthermore, program data to be distributed to the user terminals 6A, 6B . . . via the Internet 5 can be simultaneously transmitted to the plural user terminals 6A, 6B . . . that have requested the distribution, based on the standard time. Thus, a program having the same contents can be simultaneously, thus massively provided to the user terminals 6A, 6B . . . which are dispersed in an area where the Internet 5 is laid, from the distribution center 4, like general broadcasting programs.

In this manner, one unit program data DM-N selected with the program select switch SW1 (FIG. 7) can be simultaneously distributed to the plural user terminals 6A, 6B . . . based on the corresponding time channel table data TCDAT, as picture information URL1, URL2 . . . that sequentially change (FIG. 6). When the user selects another program in the middle of or after the distribution of the one unit program data DM-N, as shown in FIG. 6, time channel table data TCDAT transmitted from the user terminals 6A, 6B . . . to the program control server 3 is changed to TCDAT-1, and accordingly the frame information specification data FADAT is changed to FADAT-1, and accordingly program picture data and commercial picture data distributed from the program distribution server 2 are changed. As a result, changed picture information URL11, URL12 . . . can be immediately distributed to the user terminals 6A, 6B . . . which have changed the specification of the program.

When the user terminal 6A, 6B . . . which has been received the distribution of program information transmits stop information to the Internet 5, the program control server 3 stops the program distribution.

(1-3) Storage of Commercial Link Specification Data

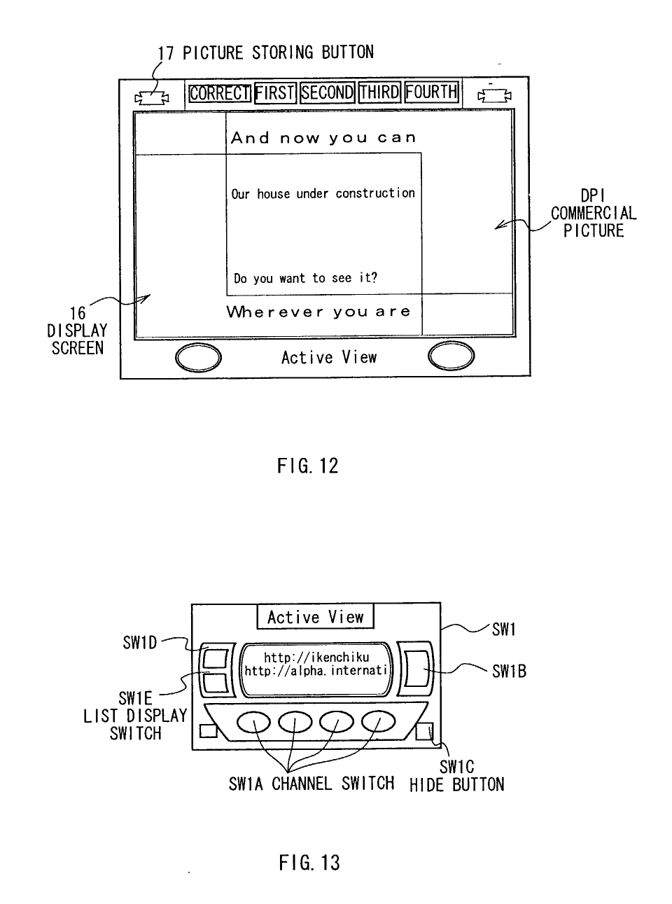

As shown in FIG. 12, by providing a picture storing button (that is, bookmark button) 17 on the display screen 16 of a user terminal 6A, 6B . . . , the user can store interesting pictures out of the pictures being sequentially displayed.

That is, as shown in FIG. 12, the commercial picture DPI can be displayed on the display screen 16 based on the timetable data TMDAT having the commercial link specification data CMDAT inserted therein, as described above with reference to FIG. 1 to FIG. 11.

When the user operates the picture storing button 17 while the commercial picture DPI is displayed on the display screen 16, the commercial link specification data CMDAT is stored in the memory of the user terminal 6A, 6B . . . .

In a state where the program select switch SW1 is displayed on the display screen 16 of the user terminal 6A, 6B . . . as shown in FIG. 13 after a program finishes, commercial link specification data “, http//iKenchiku.net,” is displayed as a first stored commercial, and at the same time, commercial link specification data “http//alpha.international.,” is displayed as a second stored commercial, based on the stored commercial link specification data CMDAT.

Under this condition, when the user specifies one out of these commercial link specification data CMDAT, the user terminal 6A, 6B . . . links to the commercial server 7A, 7B . . . specified by the specified commercial link specification data.

Thus, commercial pictures stored in the commercial servers 7A, 7B . . . can be provided to the user terminal 6A, 6B . . . of the user who has specified the picture, via the Internet 5.

In this way, when a program finishes, the user can view interesting commercial pictures at any time without temporal limitation.

(1-4) Program Information Receiving Method of User Terminal

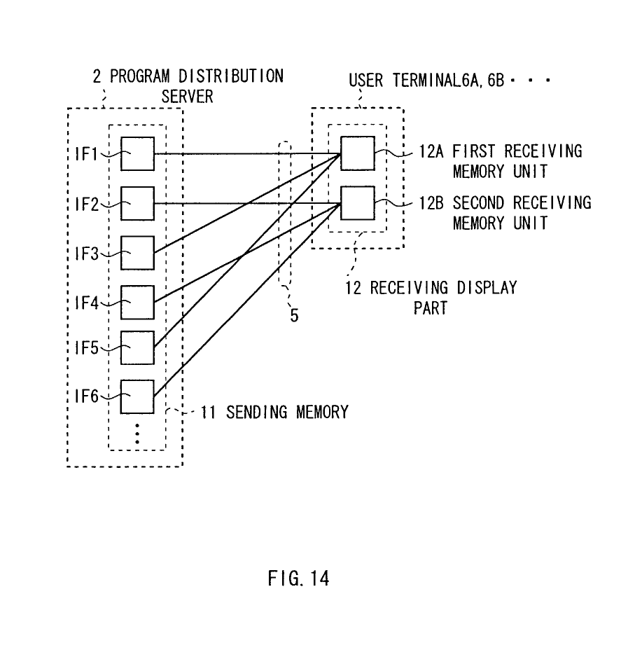

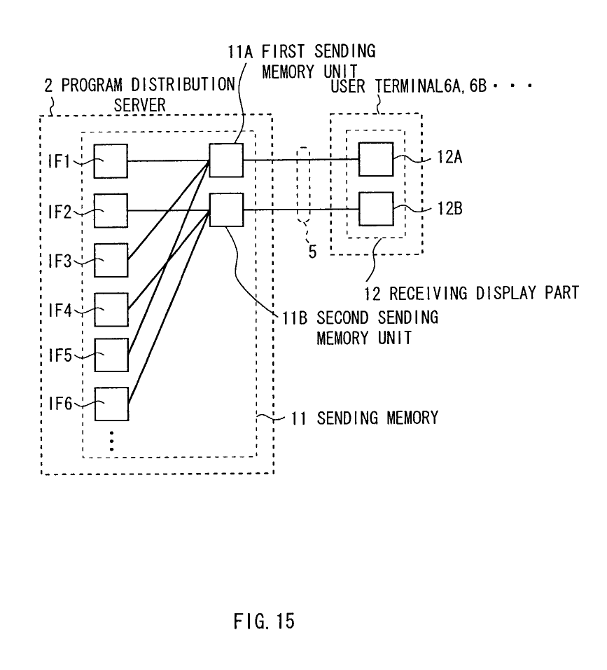

When the program distribution server 2 of the distribution center 4 (FIG. 1) distributes program information to the user terminals 6A, 6B . . . via the Internet 5, the program distribution server 2 is arranged to switch a receiving method of each user terminal 6A, 6B . . . between a sequential receiving method shown in FIG. 14 and an overwrite receiving method shown in FIG. 15.

As shown in FIG. 14, each user terminal 6A, 6B . . . has a pair of receiving memory units 12A and 12B which alternatively receives program information IF1, IF2 . . . via the Internet 5. While the first receiving memory unit 12A receives the program information IF1, IF2 . . . via the Internet 5, program information which has completed to be received by the second receiving memory unit 12B is displayed.

Then, when the program information has completed to be received by the first receiving memory unit 12A, the reception state is switched to receive program information via the Internet 5 by the second receiving memory unit 12B, and the program information which has been received by the first receiving memory unit 12B is displayed.

This configuration allows the receiving memories 12 of the user terminal 6A, 6B . . . to have sufficient time, so that the user terminal 6A, 6B . . . can easily control the display processing of a relatively large amount of file such as motion picture and also can display pictures without sudden changes on the display.

However, in the case of receiving the distribution of program distribution data with sound such as to output sounds while taking in the data, that program information might arrive at such timing that sound starts in the middle of reading the program information by the receiving memory unit performing the receiving operation.

In such case, the program distribution server 2 compresses and then transmits the data of the program information to the receiving memory unit 12A or 12B.

For such compressed program information, as shown in FIG. 5, frame information specification data “cab” representing being compressed picture data is used as frame information specification data.

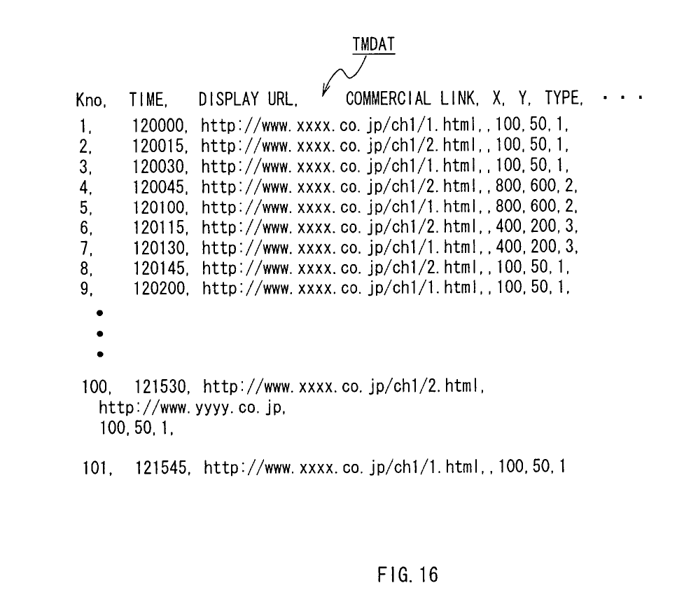

If such compression is unnecessary, the program information is transmitted without compression, as shown in FIG. 16.

In the case of FIG. 5, to the frame information specification data of the frame numbers “4” to “6”, the type data “cab” representing that “image has been compressed” is added. It should be noted that the type data “html” is added to frame information specification data for program information “to be transmitted without compression”.

Thereby, when the compressed program information is stored in one receiving memory unit of the receiving memories 12 via the Internet 5, all information is taken in the user terminal 6A, 6B . . . and then decompressed, so that sound starts at a timing when it returned to the original program information. Thus, a problem in that only sound starts can be effectively solved.

By the sequential receiving method of FIG. 14, the receiving display part 12 of the user terminal 6A, 6B . . . can have sufficient time to perform the receiving operation, so that program information can be taken in the user terminal 6A, 6B . . . without interruption.

By the way, by the sequential receiving method of FIG. 14, all of program information to be distributed from the program distribution server 2 to the user terminal 6A, 6B . . . can be received by the receiving memory 12 without fail. However, it is necessary that after the program information is once received by the user terminals 6A, 6B . . . , the program information should be all deleted, for example, for a copyright protection.

In such case, as shown in FIG. 15, the program distribution server 2 is provided with a pair of first and second sending memory units 11A and 11B as a sending memory 11, and thereby program information IF1, IF2, IF3 . . . in the first and second sending memory units 11A and IB are sequentially and alternately overwritten.

Then, the program distribution server 2 makes the first and second receiving memory units 12A and 12B of the receiving memory 12 of the user terminal 6A, 6B . . . directly receive the program information from the first and the second sending display units 11A and 11B of the sending memory 11 via the Internet 5.

Thereby, only two pieces of program information out of program information distributed from the sending memory 11 of the program distribution server 2 remain in the first and the second receiving memory units 12A and 12B.

Therefore, according to the configuration of FIG. 15, while program information is taken in the user terminal 6A, 6B . . . with one receiving memory unit out of the pair of receiving memory units 12A and 12B of the receiving display part 12, new program information overwrites the former program information in the corresponding sending memory unit for data in the other receiving memory unit. Thereby, a fear that the remained program information is unnecessarily taken in the user terminal 6A, 6B . . . can be effectively avoided; thus, a program information distribution system capable of surely protecting copyright can be realized.

According to the above configuration, program information without a copyright protection problem can be distributed to the user terminals 6A, 6B . . . with a sufficient time by the sequential receiving method shown in FIG. 14. On the contrary, with respect to program information which needs a copyright protection, the program distribution server 2 uses the overwrite distribution method shown in FIG. 15, thus realizing an information distribution system 1 capable of practically and sufficiently meeting the distribution conditions of programs.

(1-5) Distribution of High Resolution Motion Picture Data

In the case where program information including high resolution motion picture data is distributed from the program distribution server 2 of the distribution center 4 to a user terminal 6A, 6B . . . via the Internet 5 in the information distribution system 1 of FIG. 1, if the Internet 5 does not have a large transmission speed, the mass program information is previously transmitted to the user terminal 6A, 6B . . . so as to be displayed at the display standard time of the user terminal 6A, 6B . . . .

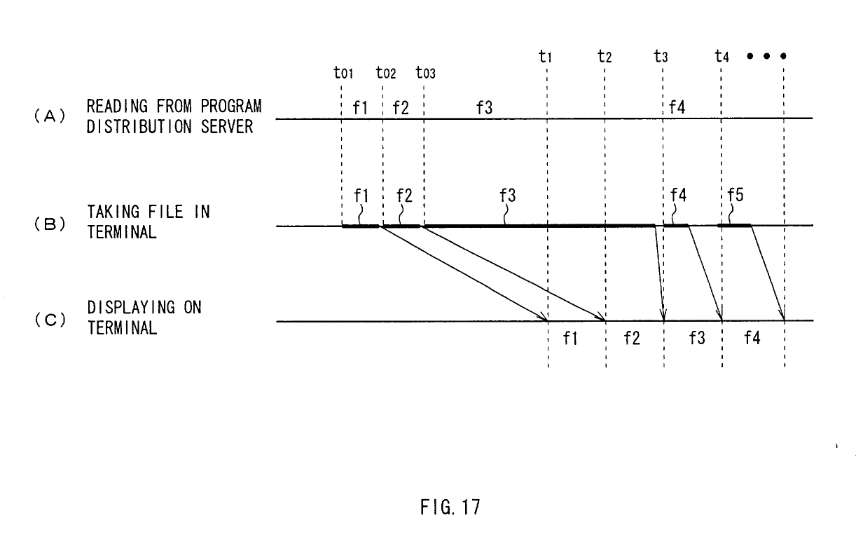

For instance, in the case of displaying first, second, third, fourth . . . program pictures f1, f2, f3, f4 . . . on the user terminals 6A, 6B . . . at time of t₁, t₂, t₃, t₄ . . . in FIG. 17, respectively, if the third program information data f3 is high resolution motion picture data, the data amount of the third program information data f3 is extremely large.

Therefore, the program control server 3 starts to read out the program information data f3, which is transmitted to the user terminal 6A, 6B . . . , from the program distribution server 2 at time of t₀₃, that is a ten minutes before display time t₃ of program information data f3, to start the transmission from the program distribution server 2 to the user terminal 6A, 6B . . . .

Accordingly, the first and the second program information data f1 and f2 previous to the third program information data f3 are transmitted from the program distribution server 2 to the user terminal 6A, 6B . . . at time, t₀₁ and t₀₂, that are ten minutes before display time, t₁ and t₂.

Practically, when the timetable data TMDAT is created, data on the reading time t₀₁, t₀₂, t₀₃ for the first, the second and third program information data f1, f2, f3 is added as frame display time data to the timetable data TMDA which is then distributed from the program control server 3 to the user terminals 6A, 6B . . . , and thereby the program information data can be distributed from the program distribution server 2 to the user terminals 6A, 6B . . . so as to be displayed at display time.

(1-6) Distribution of Program Information Data by Dispersion

In the case of distributing program information data to user terminals 6A, 6B . . . based on the standard time in the information distribution system 1 of FIG. 1, because the same program information data must be distributed to all the terminals in synchronization, there is a fear that when there are a vast number of user terminals 6A, 6B . . . and each frame information specification data FRDAT of the timetable data TMDAT (FIG. 5) is transmitted, traffic on the Internet 5 is congested and they cannot be distributed safely.

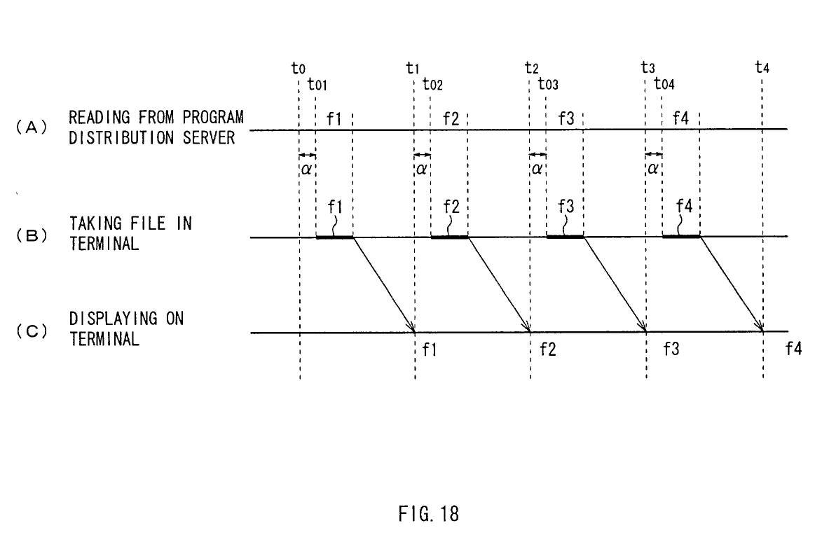

In such case, as shown in FIG. 18, the distribution start time of t₀₁, t₀₂, t₀₃, t₀₄ for the first, the second, the third, the fourth program information data f1, f2, f3, f4 to the user terminals 6A, 6B . . . is selected to time that is delayed by time α from the display time t₀, t₁, t₂, t₃ of the preceding program information. Because there is no program information preceding to program information data “f” in this case, a virtual time t₀ is assumed.

This delay time α is selected so that the user terminals 6A, 6B . . . have different values according to the congestion of the traffic on the Internet 5 from the program distribution server 2 to the user terminals 6A, 6B . . . . Thereby, different information transmission time is set within a time range from the transmission time of the preceding program information data to the transmission time of the present program information data.

Thereby, when the first, the second, the third, the fourth . . . program information data f1, f2, f3, f4 . . . are transmitted to the user terminals 6A, 6B . . . from the program distribution server 2, since the transmission start time t₀₁, t₀₂, t₀₃, t₀₄ . . . is different for each user terminal 6A, 6B . . . , it is possible to avoid the congestion of traffic on the Internet 5 when the program information data is distributed to the user terminals 6A, 6B . . . . Thus, an information distribution system 1 that can make all of the user terminals 6A, 6B . . . , which have requested a distribution, simultaneously and reliably display a program at a display time determined based on the standard time can be realized.

(2) Second Embodiment

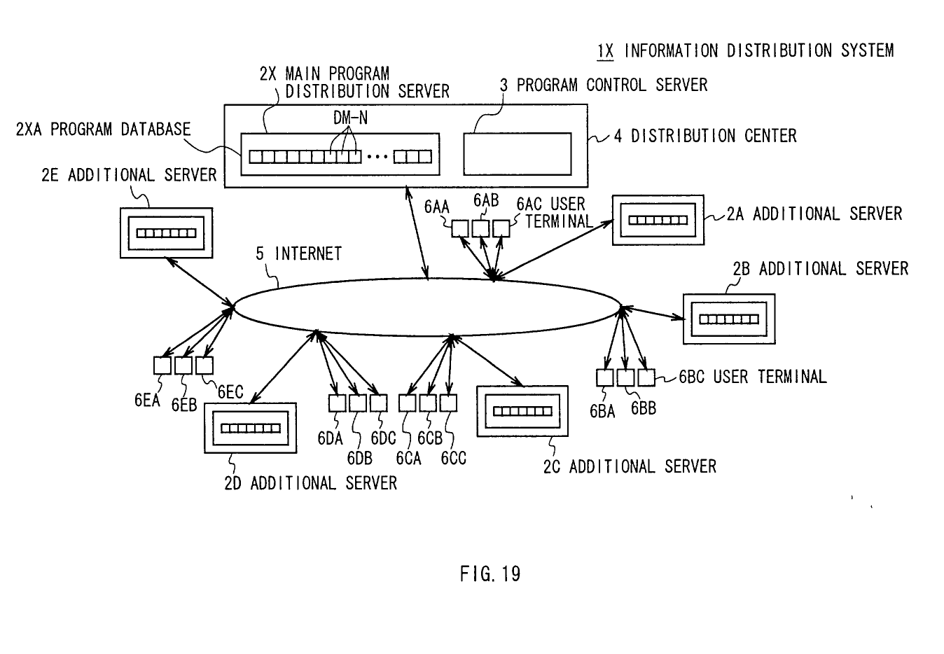

FIG. 19 shows an information distribution system 1X of the second embodiment. In this information distribution system 1X in which the same reference numerals are applied to parts corresponding to those of FIG. 1, program information data is simultaneously distributed from a program database 2XA of a main program distribution server 2X provided in a distribution center 4, via plural additional distribution servers 2A, 2B . . . 2E dispersed in a broad area, to the user terminals (6AA, 6AB, 6AC), (6BA, 6BB, 6BC) . . . (6EA, 6EB, 6EC) each near the additional distribution server 2A, 2B . . . 2E .

The main program distribution server 2X has a similar configuration to the information distribution server 2 described above with reference to FIG. 1. Therefore, the main program distribution server 2X distributes channel table data CHDAT similar to the data described above with reference to FIG. 4, to the user terminals (6AA, 6AB, 6AC), (6BA, 6BB, 6BC) . . . (6EA, 6EB, 6EC) via the Internet 5, so that the frame-contents-of-program data Dmnp (FIG. 3) of the distribution information on the first to the fourth channels (FIG. 2) in the main program distribution server 2X can be specified with the user terminals (6AA, 6AB, 6AC), (6BA, 6BB, 6BC) . . . (6EA, 6EB, 6EC).

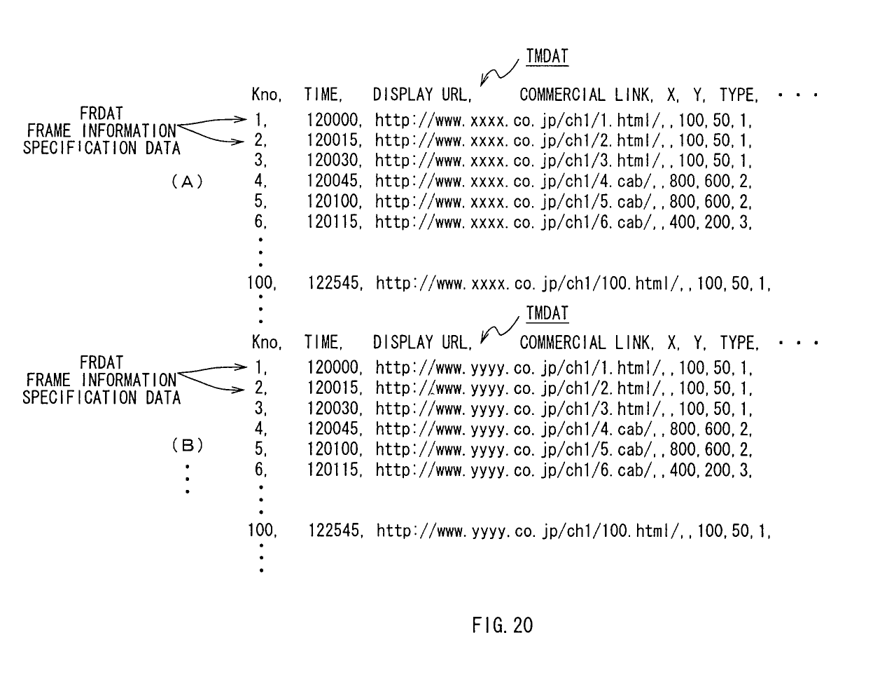

On the other hand, as shown in FIGS. 20(A), 20(B) . . . , instead of the timetable specification data “timetable.dat” of the “channel information address data” (channel URL) of the channel table data CHDAT, the program control server 3 includes “additional distribution server specification data” specifying an additional distribution server 2A, 2B . . . 2E (“http//www.xxxx.co.jp/ch1/1.html”, “http//www.yyyy.co.jp/ch1/1.html”. . . ) as “frame display address data” (display URL).

When an active view system is opened, the user terminals (6AA, 6AB, 6AC), (6BA, 6BB, 6BC) . . . corresponding to the additional distribution servers 2A, 2B . . . receive the distribution of the channel table data CHTAD (FIG. 4) that is common among all the user terminals (6AA, 6AB, 6AC), (6BA, 6BB, 6BC) . . . , and the distribution of timetable data TMDAT including the “frame information address data” of the corresponding additional distribution servers 2A, 2B . . . as timetable data TMDAT, as shown in FIGS. 20(A), 20(B) . . . .

In this connection, the “additional distribution server specification data” for the additional distribution server 2A is assigned to distribute program information data to its neighbor user terminals 6AA, 6AB and 6AC, the “additional distribution server specification data” for the additional distribution server 2B is assigned to distribute program information data to its neighbor user terminals 6BA, 6BB and 6BC, . . . , and the “additional distribution server specification data” for the additional distribution server 2E is assigned to distribute program information data to its neighbor user terminals 6EA, 6EB and 6EC.

In the information distribution system 1X of FIG. 19, the program control server 3 previously distributes the distribution information INF on the first to the fourth channels (FIG. 2) that have been previously stored in the main program distribution server 2X, to the additional distribution servers 2A, 2B . . . via the Internet 5, before distributing the channel table data CHDAT and the timetable data TMDAT to the user terminals (6AA, 6AB, 6AC), (6BA, 6BB, 6BC) . . . .

Under this condition, when the user transmits the distribution request of channel table data CHDAT corresponding to desired unit program data DM-N, from his user terminal (6AA, 6AB, 6AC), (6BA, 6BB, 6BC) . . . to the program control server 3, since the distribution request from the user terminal (6AA, 6AB, 6AC), (6BA, 6BB, 6BC) . . . includes the frame information address data (display URL) for specifying the corresponding additional distribution server 2A, 2B . . . “http//www.xxxx.co.jp/ch1/1.html/”, “http//www.yyyy.co.jp/ch1/1.html”. . . , the user terminal (6AA, 6AB, 6AC), (6BA, 6BB, 6BC) . . . which has transmitted the distribution request reads the specified unit program data DM-N from the allotted additional distribution server 2A, 2B . . . via the Internet 5.

For instance, out of the user terminals (6AA, 6AB, 6AC) that belong to the additional distribution server 1A, the user terminal 6AA reads the program information from the corresponding additional distribution server 1A via the Internet 5 based on the frame information specification data FRDAT (specifying the additional distribution server 2A) included in the timetable data TMDAT (FIG. 20) specified by the channel table data on the first line in the channel table data CHDAT of FIG. 4.

At this time, the user terminal 6AA sequentially reads program information data every 15 seconds for one hour; program information data on the first channel at 12:00:00, program information data at 12:00:15, program information data at 12:00:30, . . . , from the additional distribution server 1A allotted to the user terminal 6AA, based on the timetable data TMDAT.

In the information distribution system 1X of FIG. 19, program information data can be distributed from the additional distribution servers 2A, 2B . . . 2E which are connected to the Internet 5 and dispersed in a broad area, to the user terminals (6AA, 6AB, 6AC), (6BA, 6BB, 6BC) . . . near the additional distribution servers 2A, 2B respectively. Thereby, program information can be distributed so as to be practically and almost simultaneously displayed on each user terminal (6AA, 6AB, 6AC), (6BA, 6BB, 6BC) . . . .

Therefore, the distribution of program information data can be dispersed in a broad area so as not to be concentrated in a part of the Internet 5 (more particularly, a part that the distribution center 4 is connected to). Thus, a fear that the Internet 5 is partly congested can be effectively avoided.

Accordingly, such an information distribution system 1X can have impressive effects in applying to the case of a large volume of program information such as motion picture.

(3) Third Embodiment

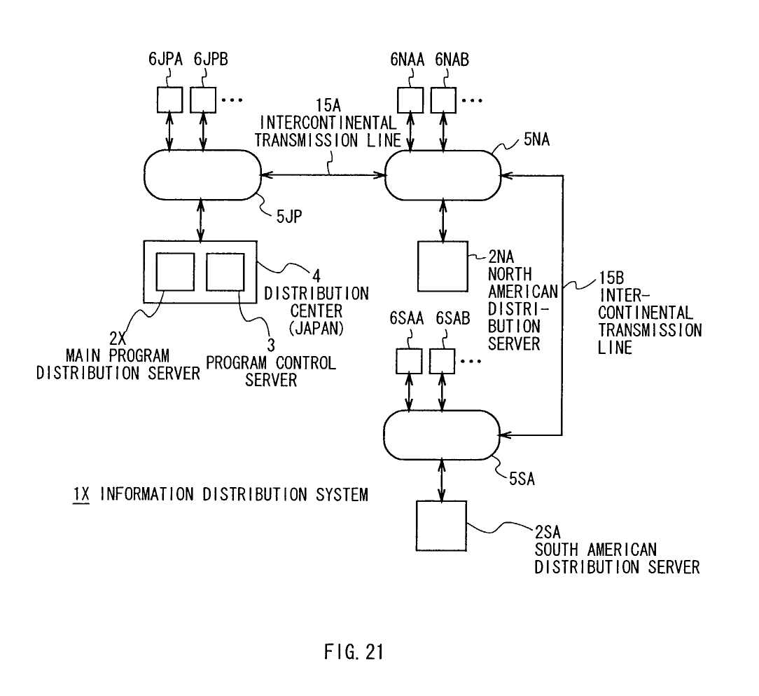

Referring to FIG. 21 showing the third embodiment in which the same reference numerals are added to parts corresponding to those of FIG. 19, an information distribution system 1X has a distribution center 4 in Japan, and program information data is distributed from a main program distribution server 2X to Japanese user terminals 6JPA, 6JPB . . . via the Japanese Internet 5JP under the control of a program control server 3.

In addition, the program control server 3 in the distribution center 4 connected to the Japanese Internet 5JP controls an additional distribution server 2NA disposed in North America via a North American Internet 5NA connected to the Japanese Internet 5JP with an intercontinental transmission line 15A, so as to previously distribute the program information data of the main program distribution server 2X in the Japanese distribution center 4, to the North American additional distribution server 2NA via the Japanese Internet 5JP, the intercontinental transmission line 15A and the North American Internet 5NA.

When a North American user terminal 6NAA, 6NAB . . . connected to the North American Internet 5NA transmits the distribution request of program information to the program control server 3 in the distribution center 4, the program control server 3 distributes the requested program information data from the North American additional distribution server 2NA to the North American user terminal 6NAA, 6NAB . . . .

Furthermore, a South American additional distribution server 2SA is connected to the South American Internet 5SA connected to the North American Internet 5NA, with an intercontinental transmission line 15B, and the program control server 3 in the Japanese distribution center 4 controls this South American additional distribution server 2SA via the Japanese Internet 5JP, the intercontinental transmission line 15A, the North American Internet 5NA, the intercontinental transmission line 15B and the South American Internet 5SA, so as to previously distribute program information data previously distributed to the North American additional distribution server 2NA, to the South American additional distribution server 2SA via the North American Internet 5NA, the intercontinental transmission line 15B and the South American Internet 5SA.

When a South American user terminal 6SAA, 6SAB . . . transmits the distribution request of program information data to the program control server 3 via the South American Internet 5SA, the intercontinental transmission line 15B, the North American Internet 5NA, the intercontinental transmission line SA and the Japanese Internet 5JP, the program control server 3 makes the South American additional distribution server 2SA distribute the program information data to the South American user terminal 6SAA, 6SAB . . . .

In the information distribution system 1X of FIG. 21, the Japanese user terminals 6JPA, 6JPB . . . , the North American user terminals 6NAA, 6NAB . . . and the South American user terminals 6SAA, 6SAB . . . can efficiently read program information from the respective nearest distribution servers 2X, 2NA and 2SA on respective continents, by the program control server 3 provided in the Japanese distribution center 4.

(4) Fourth Embodiment

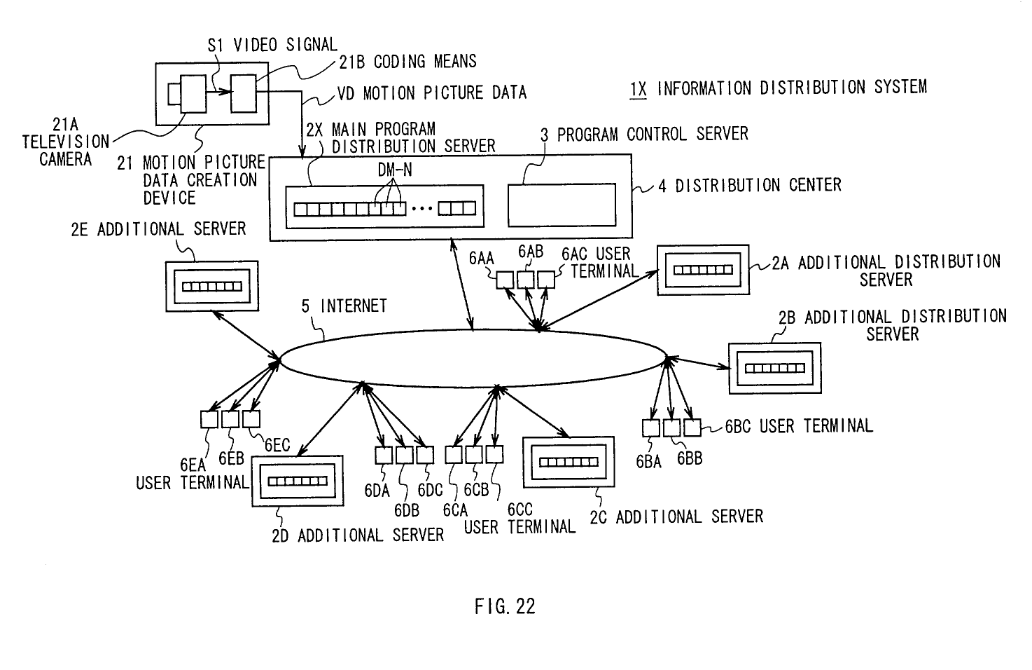

Referring to FIG. 22 which shows a fourth embodiment in which the same reference numerals are added to parts corresponding to those of FIG. 19, motion picture data VD is transmitted from a motion picture data creation device 21 to a main program distribution server 2X of a distribution center 4.

The motion picture data creation device 21 converts a video signal S1 corresponding to the image of the subject picked up by a television camera 21A into a digital signal and then compresses it with a coding means 21B, and then transmits the resultant as motion picture data VD.

In the case of this embodiment, the main program distribution server 2X creates unit program data DM-N having the five-minute motion picture data VD as frame-contents-of-program data Dmnp, and sequentially distributes the frame-contents-of-program data Dmnp to additional distribution servers 2A, 2B . . . 2E via the Internet 5 as live mode program information data.

In this case, while the additional distribution servers 2A, 2B . . . 2E can receive unit program data DM-N from the main program distribution server 2X, the corresponding user terminals (6AA, 6AB, 6AC), (6BA, 6BB, 6BC) . . . (6EA, 6EB, 6EC) can read that data. Therefore, the users of the user terminals (6AA, 6AB, 6AC), (6BA, 6BB, 6BC) . . . (6EA, 6EB, 6EC) can watch the subject image picked up by the television camera 21A of the motion picture data creation device 21, on the displays of the user terminals (6AA, 6AB, 6AC), (6BA, 6BB, 6BC) . . . (6EA, 6EB, 6EC), with a time delay due to the transmission of the picture information, but as almost simultaneous images (that is, in a live mode.)

In the information distribution system 1X of FIG. 22, the motion picture data VD to be transmitted from the motion picture data creation device 21 has much larger amount of data as compared with static pictures. That is, the data amount of unit program data DM-N to be distributed to the additional distribution servers 2A, 2B . . . 2E becomes huge.

However, the number of user terminals (6AA, 6AB, 6AC), (6BA, 6BB, 6BC) . . . (6EA, 6EB, 6EC) allotted to each additional distribution server 2A, 2B . . . 2E can be limited to the number so that the above mass unit program data DM-N can be read from the additional distribution server 2A, 2B . . . 2E for a short time (in this example, three). Therefore, the users of the user terminals (6AA, 6AB, 6AC), (6BA, 6BB, 6BC) . . . (6EA, 6EB, 6EC) can watch images picked up by the television camera 21 without so much time lag, like a live mode.

In addition, in the case where all of the user terminals (6AA, 6AB, 6AC), (6BA, 6BB, 6BC) . . . (6EA, 6EB, 6EC) directly read motion picture data from the main program distribution server 2X, there is a large time lag to display images on a display (it is considerably delayed from a pick-up time by the television camera 21A) according to the transmission speed of the Internet 5, the degree of congestion on a traffic, the number of connected user terminals (6AA, 6AB, 6AC), (6BA, 6BB, 6BC) . . . (6EA, 6EB, 6EC), etc. However, the information distribution system 1X of the fifth embodiment as shown in FIG. 22 can effectively solve such problems.

(5) Fifth Embodiment

(5-1) Whole Construction

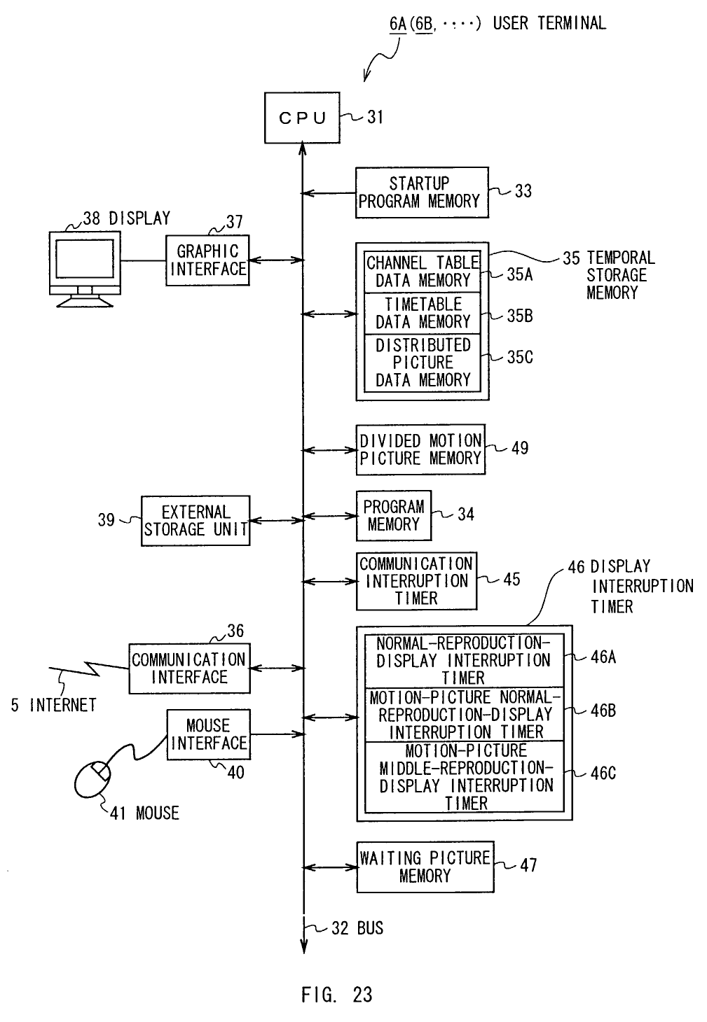

An information distribution system 1 of the fifth embodiment has a similar structure to that described with reference to FIG. 1, and user terminals 6A, 6B . . . has the construction shown in FIG. 23.

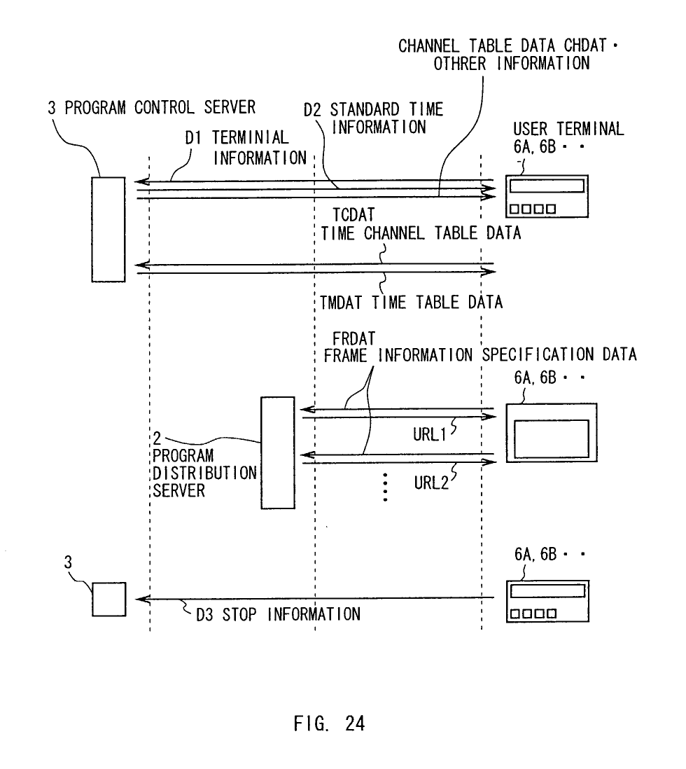

In each user terminal 6A, 6B . . . , a CPU (Central Processing Unit) 31 starts up the processing operation of the user terminal 6A, 6B . . . by a startup program memory 33 composed of a ROM via a bus 32, and executes the program of a program memory 34 composed of a RAM being a hard disk, with a temporal storage memory 35 composed of a RAM. Thereby, in FIG. 24 where the same reference numerals are applied to parts corresponding to those of FIG. 6, the user terminal 6A, 6B . . . executes communication processing of the channel table data CHDAT and the timetable data TMDAT with the program control server 3, and executes information communication processing of the frame specification data FRDAT with the program distribution server 2.

With respect to data communication between the user terminal 6A, 6B . . . , and the program distribution server 2 or the program control server 3, the CPU 31 controls a communication interface 36 via the bus 32 to store data transmitted from the Internet 5, in the temporal storage memory 35 where the data is then processed, and then displays the resultant on a display 38 having a GUI structure with a graphic interface 37 via the bus 32, and if an occasion arises, the CPU 31 stores it in an external storage unit 39 via the bus 32.

The user of the user terminal 6A, 6B . . . enters specification information via a mouse interface 40 connected with the bus 32 by operating the cursor on the display 38 with a mouse 41 serving as a data input means, and transmits communication information to the Internet 5 via the communication interface 36.

(5-2) Program Startup Processing Procedure

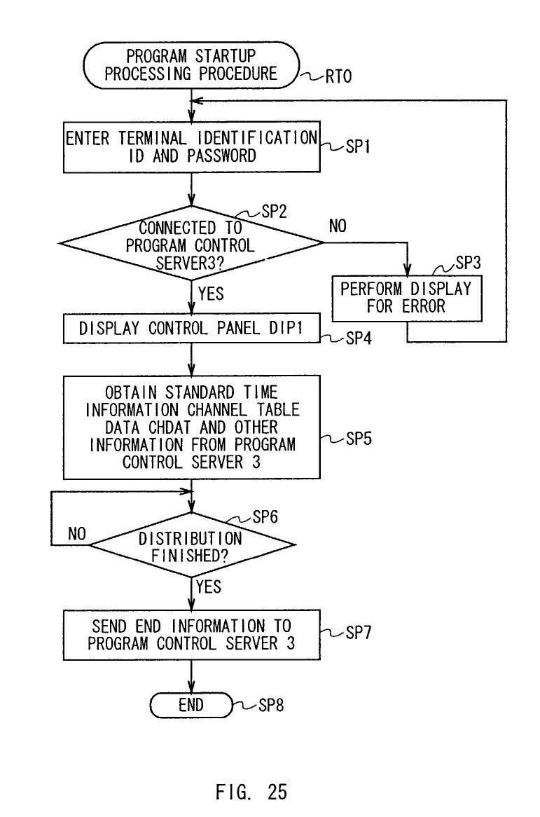

To start up the programs of the user terminal 6A, 6B . . . , the CPU 31 starts up the program memory 34 in accordance with the program in the startup program memory 33 and executes a program startup processing procedure RT0 shown in FIG. 25.

When the user enters the terminal identification ID and password at step SP1, the CPU 31 executes processing to transmit these as terminal information D1 (FIG. 24) to the program control server 3.

Then, the CPU 32 detects at step SP2 whether a connection has been established with the program control server 3, and when a negative result is obtained, it means that the ID password was not confirmed, and then the CPU 31 performs display for indicating an error at step SP3, and returns to the step SP1 for the input processing of the terminal identification ID and password again.

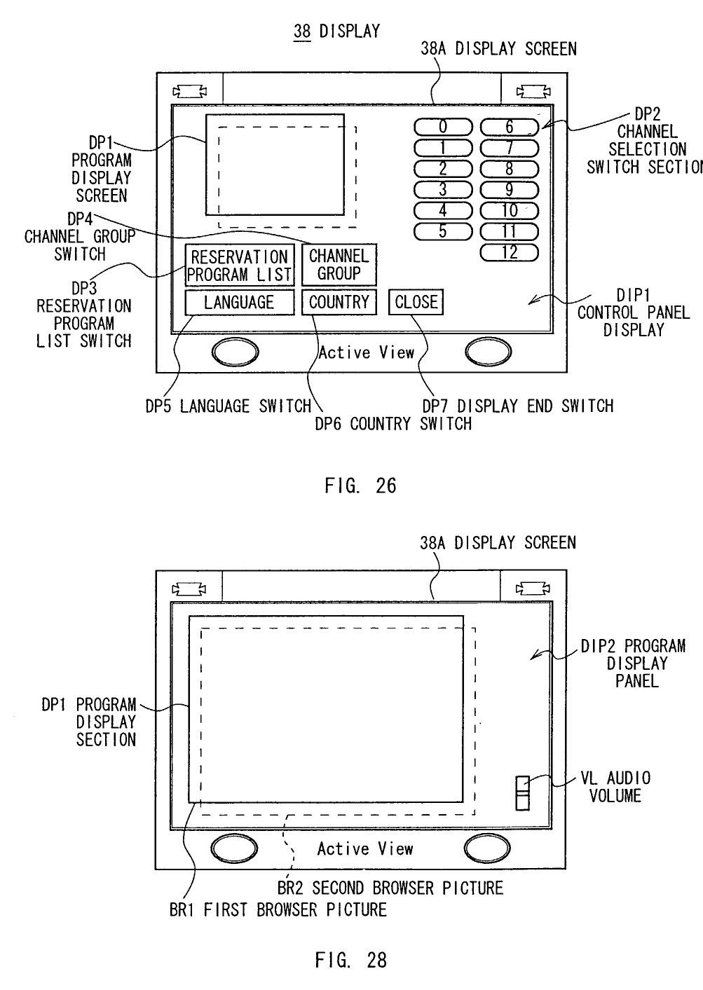

When an affirmative result is obtained at step SP2, then the CPU 31 proceeds to step SP4 to display a control panel display DIP1 on the display screen 38A of the display 38 as shown in FIG. 26.

The control panel display DIP1 includes a program display section DP1 for displaying distributed program pictures at the top left thereof, and also a channel selection switch section DP2 for selecting a channel on which distribution should be performed, at the top right thereof (in this case, zero to twelfth channels are selectable).

Thereby, the user can display the selected program on the program display section DP1 by selecting and operating one of the channel switches on the channel selection switch section DP2 while the control panel display DIP1 is displayed.

In this embodiment, the control panel display DIP1 includes a reservation program list switch DP3 (which is operable for program reservation), a channel group switch DP4 (which is operable for selecting one channel group to be allotted to the switches of the channel selection switch section DP2, out of a plurality of channel groups), a language switch DP5 (which is operable for selecting a language for a program), and a country switch DP6 (which is operable for select the country where a transmission network, such as the Internet 5, is connected to the user terminal 6A, 6B . . . ), below the program display section DP1.

In addition, a display end switch DP7 is provided at the bottom of the control panel display DIP1 to close the control panel display DIP1 by operating this switch.

Then, the CPU 31 proceeds to step SP5 to obtain the standard time information D2, channel table data CHDAT, and other information from the program control server 3 via the communication interface 36, which are then stored in a channel table data memory 35A of the temporal dealing memory 35 via the bus 32.

That is, as shown in FIG. 24, the user terminal 6A, 6B . . . sends the terminal information D1 to the program control server 3 and thereby receives the distribution of the standard time information D2, channel table data CHDAT, and other information.

Under this situation, the CPU 31 proceeds to step SP6 where it keeps the processing of this program until the display end switch DP7 is operated to terminate the distribution. This situation is that the distribution of a program or other processing is executable in accordance with a program when the user of the user terminal 6A, 6B . . . selects the program stored in the program memory 34 by operating the switch of the control panel display DIP1.

When an affirmative result is obtained at step SP6 thereafter, this means that the user has operated the display end switch DP7 to terminate the distribution of the program, and then the CPU 31 proceeds to step SP7 to send the stop information D3 to the program control server 3, and then terminates the program startup processing procedure RT0 at step SP8.

(5-3) X-Channel Button Processing Procedure

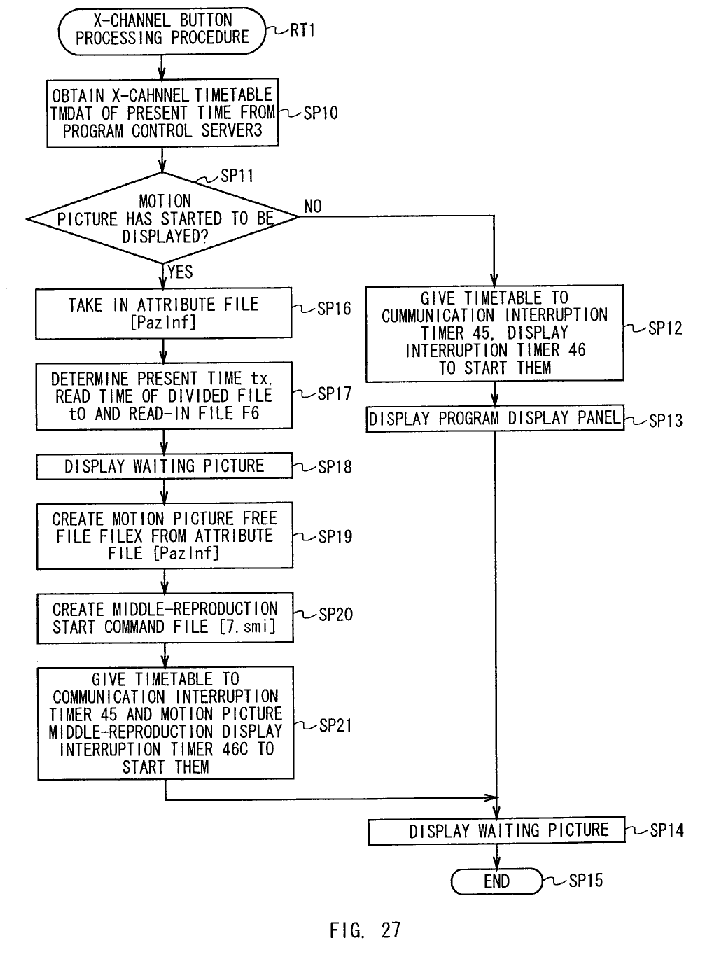

The CPU 31 executes an X-channel button processing procedure RT1 shown in FIG. 27 when the user operates one channel button (this button is referred to as “X-channel button”) of the channel selection switch section DP2 on the control panel display DIP1 under the situation of step SP6 of the program startup processing procedure RT0.

After the X-channel button processing procedure RT1 starts, the CPU 31 sends request information for the time channel table data TCDAT (FIG. 4) of the X-channel for the present time to the program control server 3 to obtain the X-channel timetable data TMDAT (FIG. 5) for the present time from the program control server 3 via the communication interface 36, which is then stored via the bus 32 in a timetable data memory 35B provided in the temporal storage memory 35.

Then, the CPU 31 proceeds to next step SP11 to judge whether the motion picture data has started to be displayed. This judgement of the CPU 31 is for determining whether the user of the user terminal 6A, 6B . . . wants to watch the motion picture program from the middle, and when a negative result is obtained, then the CPU 31 proceeds to step SP12.

In this embodiment, the user terminal 6A, 6B . . . can receive the normal picture “html”, compressed picture “cab” and motion picture “paz” as the type of pictures, as described with reference to FIG. 5. And in the case of watching motion picture of the motion picture “paz” from the middle, the CPU 31 obtains an affirmative result at step SP11. On the contrary, in the case of watching the other pictures, that is, the normal picture “html”, compressed picture “cab” and motion picture “paz” from the beginning, the CPU 31 obtains a negative result at step SP11.

At step SP12, the CPU 31 starts a communication interruption timer 45 and a display interruption timer 46 by supplying the timetable data TMDAT, and at next step SP13, the CPU 31 displays a program display panel DIP2 as shown in FIG. 28 on the display 38.

The program display panel DIP2 includes two display screens, that is, first and second browser pictures BR1 and BR2 which are alternatively created with the graphic interface 37, as described with reference to FIG. 14 and FIG. 15, and displays one picture completed out of them on a program display section DP1 (the other picture is gradually created as picture data arrives, and is displayed by switching on the program display section DP1 when being completed).

As shown in FIG. 28, an audio volume VL is displayed on the bottom right side of the program display panel DIP2, so that the user can adjust the volume with this.

The CPU 31 displays a waiting picture stored in a waiting picture memory 47, on the program display section DP1 for a fixed time (fifteen seconds, for example) at next step SP14.

Because it takes time equivalent to a delay time due to the transmission, after the user operates the X-channel button till program data is all stored in the distributed picture data memory 35C of the temporal recording memory 35, the processing of this step SP14 displays a waiting picture, such as a guide display “wait for a second” or a commercial picture described with reference to FIG. 11 and FIG. 12, so that the user does not get uneasy feelings during that time.

Then the CPU 31 terminates the X-channel processing procedure RT1 at step SP15.

When an affirmative result is obtained at step SP11, this means that the X-channel button is operated while the motion picture data is being displayed, then the CPU 31 executes the processing of step SP16 to step SP21 to start the display of pictures from the middle of the motion picture.

Generally, for the motion picture, a significantly large amount of data needs to be transmitted, as compared with still pictures. Therefore, in the case of transmitting the motion picture “paz” such as the frame number Kno=7 of FIG. 5, divided motion picture data which is obtained by dividing one motion picture into plural pictures is prepared in the program distribution server 2 in advance.

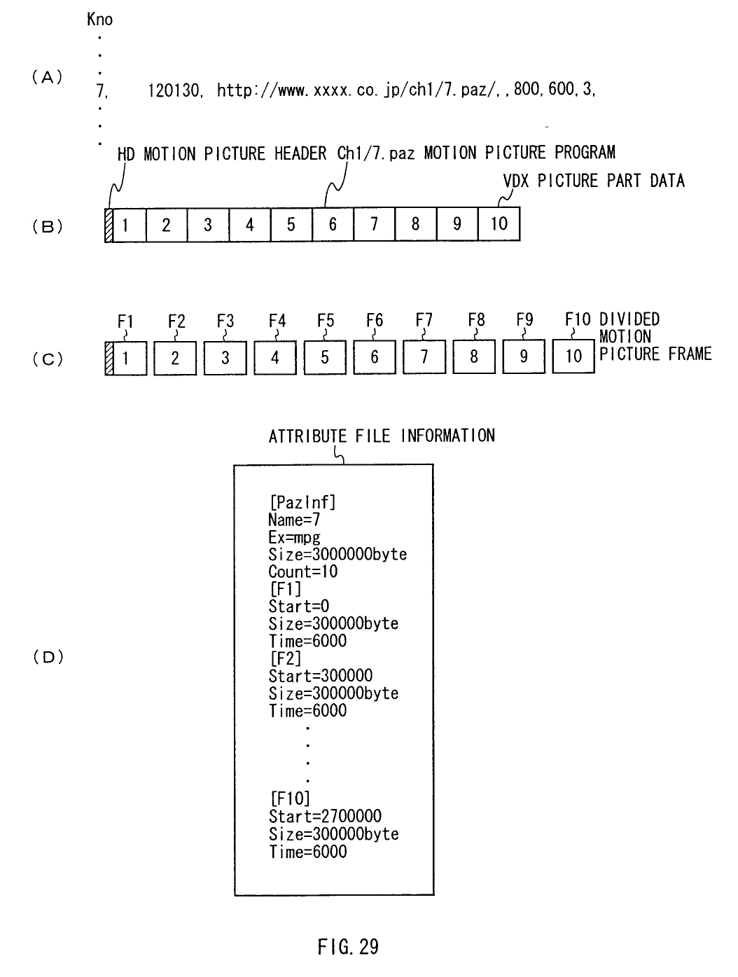

That is, in the case of specifying the frame information specification data FRDAT (FIG. 5) having the frame number Kno=7 as shown in FIG. 29(A), one motion picture program “ch1/7.paz” (ten-minute motion picture, for example) is divided into ten pieces of picture partial data VDX (one-minute picture data, for example), as motion picture data “paz” having the frame number 7 on the first channel ch1 as shown in FIG. 29(B), and then the picture partial data VDX is taken to as the first to tenth divided motion picture frame data F1 to F10 as shown in FIG. 29(C), which are previously stored in the program distribution server 2 as a series of divided motion picture data “F1·F2·. . . ·F10”

The first divided motion picture frame data Fl contains a motion picture header HD having control information indicating the structure of the ten pieces of picture partial data VDX of one motion picture program “ch1/7.paz” as header information. This information includes information on the data structure of the motion picture program “ch1/7.paz” such as the number, amount, data format, and display time of the picture partial data VDX, so that obtaining the motion picture header HD of the first divided motion picture frame data Fl is equal to obtaining the data structure of the motion picture program “ch1/7.paz”.

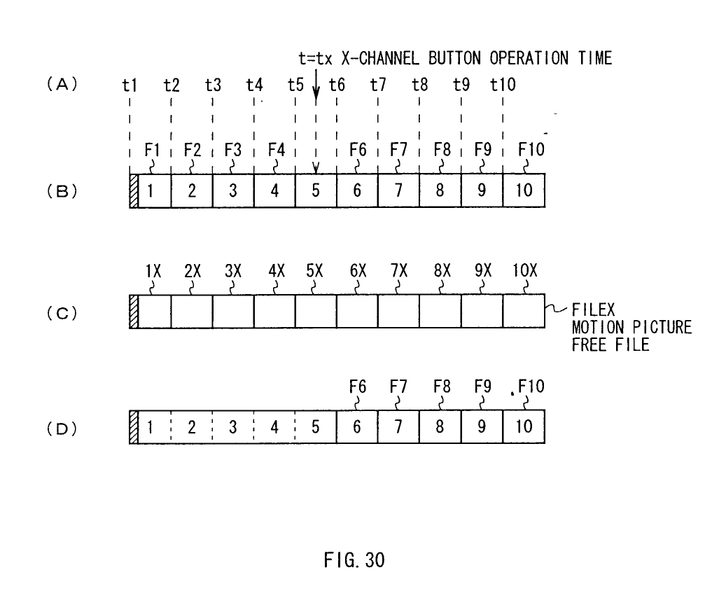

In the case where the start time for such divided motion picture frame data F1·F2· . . . ·F10 is set to 12:01:30 as the frame information specification data FRDAT of the seventh frame (Kno=7), when the X-channel button is operated at time t=tx after the start time 12:01:30 as shown in FIG. 30(A), the user terminal 6A, 6B . . . performs the processing of step SP16 to step SP21 to display only the frame data F6 to F10 after the X-channel button operation time t=tx as shown in FIGS. 30(B) to (D).

Specifically, when an affirmative result is obtained at step SP11, the CPU 31 stores attribute file information [PazInf] on a series of the divided motion picture data F1·F2· . . . ·F10, from the program control server 3 into the distributed picture data memory 35C as the timetable data TMDAT at step SP16, and then determines the divided motion picture frame data F6 to be read, based on the X-channel button operation time TX (FIG. 30(A)) and the read time t=t0 of the divided motion picture data file at step SP17, and thus it is determined that the divided motion picture frame data F6·F7·F8·F9·F10 which starts at time t=t6 after the X-channel button operation time t=tx should be displayed on the display 38.

The attribute file information “PazInf” comprises a frame name (Name=7), picture format (Ex=mpg (which means a compressed picture), data size (Size=3000000 (which means 3000000 bytes), and the number of divisions (Count=10 (which means 10 pieces of divided motion picture frame data F1 to F10), as general information.

In addition, the frame information on each of the frame data F1, F2, . . . , F10 comprises the start address (Start=0, Start=300000, . . . , Start=2700000 (representing the location of start byte), the data size (Size=300000, Size=300000 . . . Size=300000 (representing 300000 bytes), and the required time (Time=6000, Time=6000 . . . , Time=6000 (representing 60 seconds).

Then, the CPU 31 displays a waiting picture in the waiting picture memory 47 on the program display section DP1 of the display 38 at step SP18, and then creates the motion picture free file FILEX as shown in FIG. 30(C) in the divided motion picture memory 49 (FIG. 23) based on the attribute file “PazInf” taken in the distributed picture data memory 35C.

As this motion picture free file FILEX, motion picture free file FILEX composed of the header HD of the motion picture data which has been distributed by the X-channel operation time t=tx, and free file division frames 0X·1X·2X· . . . ·10X corresponding to divided motion picture frames F1 to F10 is created in the distributed picture data memory 35C.

As a result, as shown in FIG. 30(D), a memory area is created in the distributed picture data memory 35C so that the frame data F6 to F10 to be distributed after the X-channel operation time t=tx are stored in the free file division frames 6X to 10X. Then, at step SP20, the CPU 31 creates a motion-picture middle-reproduction start command file [7, smi] as shown below.

[7, smi]

<smil>

<body>

<ref clip-being=“300. os”src=“7. mpg”

</body>

</smil>

<smil>is a file name, <body>is a body, <ref clip-being=“300.os”=“7.mpg> is a command of “MPEG compressed file called 7.mpg is reproduced from 300 seconds passed”, and </body>, </smil> represent the end.

Then the CPU 31 proceeds to step SP21 to activate the communication interruption timer 45 and a motion-picture middle-reproduction-display interruption timer 46C of the display interruption timer 46 by giving the timetable to them, and then terminates the X-channel processing procedure RT1 at step SP15 following step 14 as described above.

(5-4) Picture Information Reading Processing Procedure

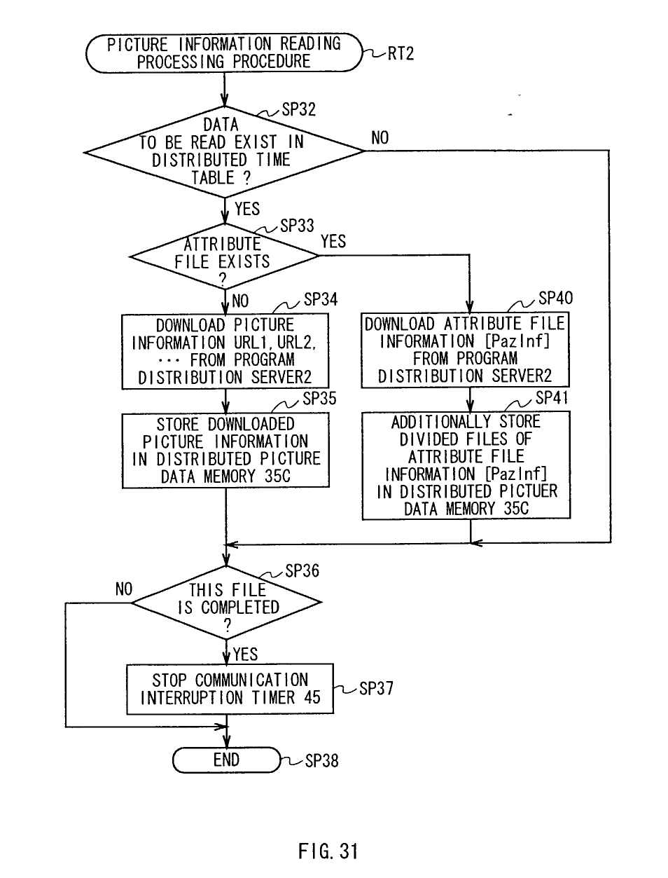

When the communication interruption timer 45 is in an active condition at steps SP12 and SP21 of the X-channel button processing procedure RT1 of FIG. 27 as described above, the CPU 31 executes the picture information reading processing procedure RT2 of FIG. 31 every time when the communication interruption timer 45 generates interruption data.

When the picture information reading processing procedure RT2 starts, the CPU 31 decides based on the distributed timetable, which has been stored in the distributed picture data memory 35, whether there is data to be read, at step SP32. When an affirmative result is obtained, it is confirmed at step SP33 whether the attribute file information “PazInf” (FIG. 29(D)) is contained in the frame information specification data FRDAT (FIG. 5) of the timetable.

When a negative result is obtained, this means that the picture of the frame information specification data FRDAT is a normal picture “html”, and then the CPU 31 proceeds to step SP34 to download the picture information URL1, URL2, . . . into the user terminal 6A, 6B . . . from the program distribution server 2.

The downloading of the picture information URL1, URL2, . . . is executed by the transmission protocol FTP.

Sequentially, the CPU 31 stores the downloaded picture information in the distributed picture data memory 35C and then proceeds to step SP36 to decide whether the file currently read has been completed. When an affirmative result is obtained, the CPU 31 stops the communication interruption timer 45 at step SP37, and then ends the picture information reading processing procedure RT2 at step SP38.

When a negative result is obtained at step SP36, on the contrary, this means that time table information may come to the timetable data memory 35B following the currently read file. In this time, the CPU 31 completes the picture information reading processing procedure RT2 at step SP38, without processing of step SP37.

Then, the CPU 31 executes the processing of steps SP32-SP33-SP34-SP35-SP36-SP37-SP38 every time when the communication interruption timer 45 generates interruption data, to performs the processing for sequentially receiving the distribution of the picture information based on the frame information specification data FRDAT of the timetable data TMDAT read in the timetable data memory 35B.

When there is no data to be read, in the timetable distributed to the timetable data memory 35C thereafter, a negative result is obtained at step SP32 and thereby the CPU 31 proceeds to step SP36.

The above processing is for the case where the timetable data for the normal pictures is distributed to the timetable data memory 35B. In the case of motion picture, on the other hand, an affirmative result is obtained at aforementioned step SP33, so the processing is for the divided motion picture data file for which the timetable data includes the attribute file “PazInf”. In this time, the CPU 31 proceeds to step SP40 to download the attribute file information “PazInf” into the distributed picture data memory 35C from the program distribution server 2, and at next step SP41, the CPU 31 additionally stores the divided files included in the attribute file information “PazInf” in the distributed picture data memory 35C.

As a result, when the divided motion picture files including the attribute file information “PazInf” are contained in the timetable distributed to the timetable data memory 35B, the divided files included in the attribute file information “PazInf” are all taken in the distributed picture data memory 53C in succession, so that they can be additionally stored together with the other picture information of the timetable.

When the divided motion picture files of the timetable finishes to be downloaded, the CPU 31 returns to step SP31 to repeat the processing for other frame information specification data FRDAT included in the timetable stored in the timetable data memory 35B. When a negative result is obtained at step SP32 thereafter, it means that the picture information of the frame information specification data FRDAT (including the normal pictures and divided motion pictures) stored in the timetable data memory 35B are all downloaded in the distributed picture data memory 35C, and in this time, the CPU 31 terminates the picture information reading processing procedure RT2 at step SP38 passing through steps SP36, SP37.

(5-5) Normal-Reproduction-Display Timer Processing Procedure

In the case where the normal-reproduction-display interruption timer 46A starts at step SP12 of the X-channel button processing procedure RT1 of FIG. 27, the CPU 31 executes the normal-reproduction-display interruption-timer processing procedure RT3 every time when this normal-reproduction-display interruption timer 46A generates interruption data.

When the normal-reproduction-display interruption-timer processing procedure RT3 starts, the CPU 31 determines at step SP41 whether the waiting time has passed, and when the waiting time has not passed, then the CPU 31 returns to above step SP41 to wait for the passage of the waiting time.

When the waiting time has passed, the CPU 31 proceeds to step SP43 to determine whether the distributed picture data exist in the distributed picture data memory 35C, and when an affirmative result is obtained, it proceeds to step SP44 to determine whether there is the picture data of the display time which matches the present time.

When an affirmative result is obtained at this time, which means that the picture data downloaded from the program distribution server 2 at the time tx (FIG. 30(A)) when the user operates the X-channel button, exist in the distributed picture data memory 35C, and in this case, the CPU 31 proceeds to step SP45 to determine whether the type of the picture data is the “html” picture (normal frame information picture), “cab” picture (MPEG compressed picture) or “paz” picture (divided motion picture).

When the CPU 31 determines that the type is the normal picture “html”, the CPU 31 proceeds to step SP46 and transmits the picture data to the graphic interface 37 to create the picture of the picture data.

In this embodiment, the graphic interface 37 alternatively creates two pictures (referred to as the first and second browser pictures) as described above with reference to FIG. 14 and FIG. 15, and the CPU 31 determines at next step SP47 which is currently created, first browser picture or second browser picture.

When the result shows the first browser picture, the CPU 31 proceeds to step SP48 to read the picture data in the first browser, displays the second browser picture at next step SP49, and proceeds to next step SP50. When the result at step SP47 shows the second browser picture, on the contrary, the CPU 31 proceeds to step SP51 to read the picture data into the second browser, displays the first browser picture at step SP52, and then proceeds to step SP50.

In this way, the CPU 31 alternatively displays picture data, which is given from the normal-reproduction-display interruption timer 46A, with the first and second browsers of the graphic interface 37, as the first and second browser pictures on the display screen of the display 38 (FIG. 28), then deletes the displayed picture data from the normal-reproduction-display interruption timer 46 at step SP50, and then terminates the normal-reproduction-display interruption-timer processing procedure RT3 at step SP57.

As a result, as long as the picture data exist in the normal-reproduction-display interruption timer 46A of the display interruption timer 46, the CPU 31 repeats the processing of steps SP43-SP44-SP45-SP46-SP47-(SP48, SP49, or SP51, SP52)-SP50-SP57 every time when the normal-reproduction-display interruption timer 46A generates interruption data, to display the pictures of all normal picture data “hmtl” on the display screen 38A of the display 38 and then to delete the displayed picture data from the normal-reproduction-display interruption timer 46A.

When it is determined at step SP45 that the picture data given to the display interruption timer 46 is the compressed picture “cab”, on the other hand, the CPU 31 decompresses the compressed picture at step SP55 to convert it into the picture data the same as the normal picture data.

After the compressed picture “cab” is converted into the picture data the same as the normal picture data, the CPU 31 proceeds to the aforementioned step SP46 and displays the decompressed picture on the display screen 38A of the display 38 and deletes the displayed picture data from the normal-reproduction-display interruption timer 46A, through the same loop as described for the normal picture “html”.

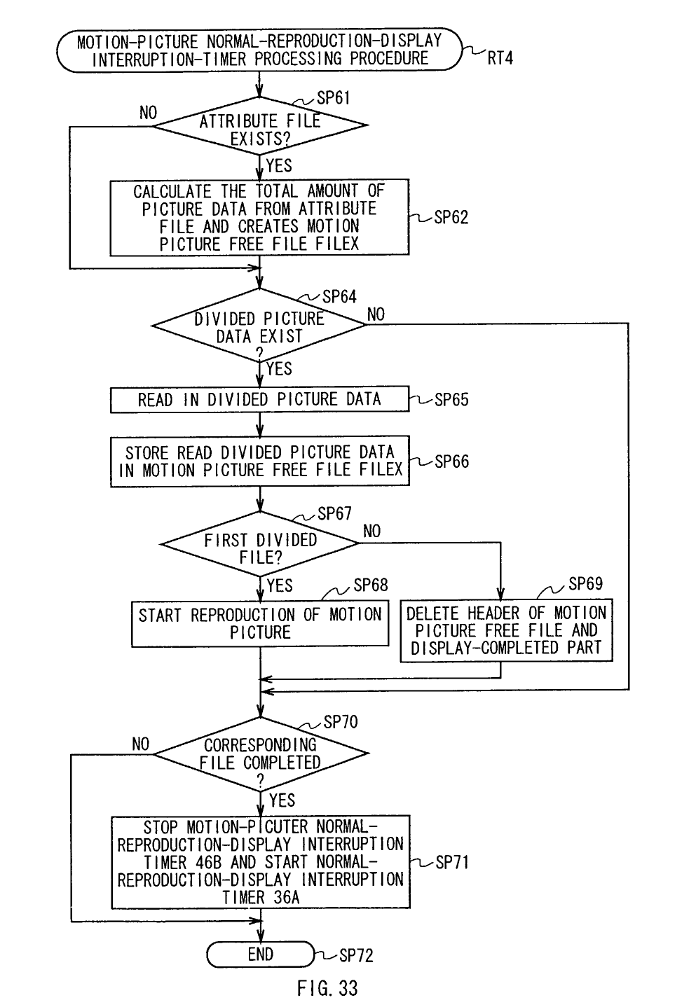

When the result at aforementioned step SP45 shows that the picture to be processed is the motion picture “paz”, on the other hand, the CPU 31 proceeds to step SP56 to stop the operation of the normal-reproduction-display interruption timer 46A and activate the motion-picture normal-reproduction-display interruption timer 46B, and then executes a motion-picture normal-reproduction-display interruption-timer processing procedure RT4 of FIG. 33 every time when the motion-picture normal-reproduction-display interruption timer 46B generates interruption data, and when this procedure ends, the CPU 31 terminates the normal-reproduction-display interruption-timer processing procedure RT3 at step SP57.

When a negative result is obtained at aforementioned step SP43, on the contrary, this means that the picture data in the distributed picture data memory 35C has been all displayed, and in this case, the CPU 31 closes the program display panel DIP2 (FIG. 28) at step SP58, and gives the stop information D3 indicating the operation status to the program control server 3 (FIG. 24) at step SP59, and then terminates the normal-reproduction-display interruption-timer processing procedure RT3 at step SP57.

Further, when a negative result is obtained at aforementioned step SP44, this means that even picture data remains in the normal-reproduction-display interruption timer 46A, the data does not need to be displayed, and in this case, the CPU 31 proceeds to aforementioned step SP58 to execute such processing as to terminate the normal-reproduction-display interruption-timer processing procedure RT3.

(5-6) Motion-Picture Normal-Reproduction-Display Interruption-Timer Processing Procedure

Referring to FIG. 33, when the motion-picture normal-reproduction-display interruption-timer processing procedure RT4 starts, the CPU 31 determines whether the picture data in the distributed picture memory 35C contain the attribute file information “PazInf”.

When an affirmative result is obtained, this means that the picture data is the divided motion picture data, and in this case, the CPU 31 proceeds to step SP62 to calculate the total amount of the picture data from the attribute file information, and creates the motion picture free file FILEX corresponding to the frame data F1 to F10, in the divided motion picture memory 49 as described with reference to FIGS. 30(A) to 30(C).

Sequentially, the CPU 31 determines at next step SP64 whether the divided picture data exist in the divided motion picture memory 35C.

When an affirmative result is obtained, the CPU 31 proceeds to step SP65 to store the divided picture data in the motion picture free file FILEX (FIG. 30(C)) of the divided motion picture memory 49.

Next, the CPU 31 determines whether the divided picture data to be firstly processed is the first divided picture data of the motion picture free file FILEX, and when an affirmative result is obtained, the CPU 31 sequentially outputs the divided pictures stored in the motion picture free file FILEX, to the graphic interface 37 to start the reproduction of the motion picture at step SP68, and then proceeds to aforementioned step SP70.

In this case, the graphic interface 37 creates a motion picture as one of the first and second browser pictures BR1 and BR2 to display the motion picture on the program display section DPI (FIG. 28).

Then, the CPU 31 executes reproduction processing of motion picture for the second, third . . . divided pictures stored in the motion picture free file FILEX, and then since a negative result is obtained at step SP67 (because the second, third . . . divided file is to be reproduced), the CPU 31 obtains a negative result at step SP67 and proceeds to step SP69 to sequentially deletes the header data HD stored in the motion picture free file FILEX and motion picture data which was already displayed on the display 38.

Thus, the motion-picture normal-reproduction-display interruption timer 46B is capable of deleting the header data and the picture data of the motion pictures already displayed, so as to secure the security of the motion pictures distributed.

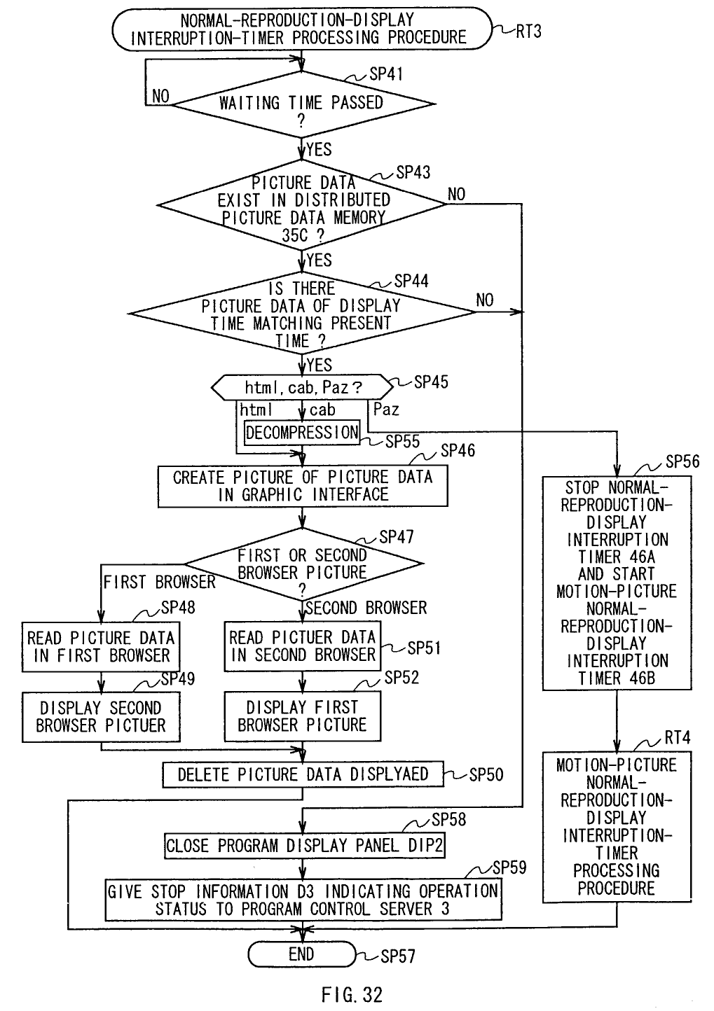

When the divided motion picture data stored in the motion picture free file FILEX is all reproduced, a negative result is obtained at step SP64, and therefore the CPU 31 determines at step 70 whether all the picture files for the files (that is, the picture files to be distributed in response to the one-operation of X-channel button) have been distributed, and when an affirmative result is obtained, the CPU 31 stops the motion-picture normal-reproduction-display interruption timer 46B and starts the normal-reproduction-display interruption timer 46A at next step SP71, and thereby making the normal-reproduction-display interruption timer 46A perform the following display processing of the picture data (FIG. 32). Then, the motion-picture normal-reproduction-display timer processing procedure RT4 is completed at step SP72.

When an affirmative result is obtained at aforementioned step SP70, which means that the processing of the files has not completed and in this case, the CPU 31 proceeds to step SP72 to complete the motion-picture normal-reproduction-display interruption-timer processing procedure RT4 immediately and repeats the processing procedure RT4 every time when the motion-picture normal-reproduction-display interruption timer 46B generates interruption data.

(5-7) Motion-Picture Middle-Reproduction-Display Interruption-Timer Processing Procedure

When the motion-picture middle-reproduction-display interruption timer 46C starts at step SP21 of the X-channel button processing procedure RT1 (FIG. 27), the CPU 31 executes a motion-picture middle-reproduction-display interruption-timer processing procedure RT5 every time when the motion-picture middle-reproduction-display interruption timer 46C generates interruption data.

At this time, the CPU 31 determines at step SP82 whether picture data exist in the distributed picture memory 35C.

When an affirmative result is obtained, which means that the motion picture data to be reproduced from the middle exist, and in the case, the CPU 31 proceeds to step SP83 to store the divided picture data into the divided motion picture memory 49, and at step SP84, stores the divided picture data from the middle, in the motion picture free file FILEX (FIG. 30(C)) at next step SP84 (stores the sixth to tenth divided picture data F6 to F10 in the sixth to tenth fee file division frames 6X to 10X of the motion picture free file FILEX, in the case of FIG. 30(D)).

Then, the CPU 31 determines at step SP 85 whether the reproduction of the motion picture has started, and when a negative result is obtained, the CPU 31 performs the reproduction from the middle by the middle-reproduction start command file [7, smi] (using the file created at step SP20 of FIG. 27) at step SP86.

When an affirmative result is obtained at step SP85, on the contrary, this means that the reproduction is not performed from the middle, and in this case, the CPU 31 proceeds to step SP87, without the middle-reproduction of step SP86.

Then, the CPU 31 stops the middle-reproduction of the motion picture data stored from the middle in the motion picture free file FILEX and proceeds to step SP87 to determine whether the file has finished. When an affirmative result is obtained, the CPU 31 stops the motion-picture middle-reproduction-display interruption timer 46C and starts the normal-reproduction-display interruption timer 46A at step SP88, thereby performing the processing of the normal-reproduction-display interruption-timer processing procedure RT3 (FIG. 32) for the processing of other picture data of the file. Then, the motion-picture middle-reproduction-display interruption-timer processing procedure RT5 is completed at step SP89.

When an affirmative result is obtained at step SP82, which means that the middle-reproduction has completed, and then the CPU 31 proceeds to step SP87 and when a negative result is obtained at step SP87, which means that the processing of the series of files to be processed in response to the operation of the X-channel button has not completed, and then the CPU 31 directly proceeds to step SP89 to terminate the motion-picture middle-reproduction-display interruption-timer processing procedure RT5.

(5-8) Operations

In the aforementioned configuration, when any channel button (that is, X-channel button) in the channel selection switch section DP2 is operated while the control panel display DIP1 is displayed on the display screen 38A of the display 38 (FIG. 26), the CPU 31 of the user terminal 6A, 6B . . . receives the X-channel timetable TMDAT corresponding to the X-channel button operation time from the program control server 3, with the channel table data memory 35A (FIG. 23) at step SP10 of the X-channel button processing procedure RT1.

The type of pictures to be distributed by the timetable TMDAT is the normal picture “html”, compressed picture “cab”, and divided motion picture “paz”, and further, there are two cases for the divided motion picture “paz”: full reproduction from the beginning and reproduction from the middle.

The CPU 31 determines the type of the picture at step SP11 (FIG. 27), and when it is determined that the motion picture is to be reproduced from the middle, the CPU 31 reproduces the motion picture free file FILEX (FIG. 30(C)) (at step SP19), creates the middle-reproduction start command file [7, smi] (at step SP20), and then gives the timetable to the communication interruption timer 45 and the motion-picture middle-reproduction-display interruption timer 46 to activate them.

In the case of the normal-reproduction-display picture data, on the other hand, the CPU 31 gives the timetable to the communication timer 45 and the display interruption timer 46 to activate them at step SP12 (FIG. 27).

In the case of the normal picture “html” and compressed picture “cab”, the communication interruption timer 45 downloads picture information from the distribution server 2 to store it into the distributed picture data memory 35C (at steps SP34, SP35 of FIG. 31). In the case of the motion picture “paz”, on the contrary, the communication interruption timer 45 downloads the attribute file information “PazInf” from the distribution server 2 and additionally stores the divided files in the attribute file information “PazInf”, into the distributed picture data memory 35C (at steps SP40, SP41 of FIG. 31).

The CPU 31 activates the display timers depending on the type of pictures, using the picture data distributed to the distributed picture data memory 35C as described above, so as to display the picture data on the program display section DP1 of the display 38.

That is, the display interruption timer 46 starts by receiving the picture data, and in the case of receiving the distribution of the normal picture “html” or compressed picture “cab”, the CPU 31 directly displays the normal picture “html” or displays the compressed picture “cab” subjected to decompression, on the display screen 38A using the first and second browsers BR1 and BR2 (at steps SP48, SP49, or SP51, SP52 of FIG. 32), in accordance with the normal-reproduction-display panel processing procedure RT3 (FIG. 32).

In the case of displaying the divided motion picture “paz” from the beginning, the CPU 31 executes the normal-reproduction-display interruption-timer processing procedure RT3 (FIG. 32), and then when the CPU 31 detects the divided motion picture “paz” (at SP45 of FIG. 32), it stops the normal-reproduction-display timer 46A and activates the motion-picture normal-reproduction-display timer 46B (SP56) to start the reproduction of the motion picture (step SP68 of FIG. 33) in accordance with the motion-picture normal-reproduction-display interruption-timer processing procedure RT4 (FIG. 33).

In order to reproduce the motion picture, the motion picture free file FILEX is created (FIG. 30(C)) in the divided motion picture memory 49 according to the total amount of the picture data based on the attribute file information [PazInf] (FIG. 29(D)), the divided picture data is stored in the motion picture free file FILEX, and thereby sequentially displaying the motion picture data on the display screen 38A every time when the motion picture data is distributed frame by frame to the distributed picture data 35C (before all frame pictures arrive) (steps SP64, SP65, SP66, SP68 of FIG. 33).

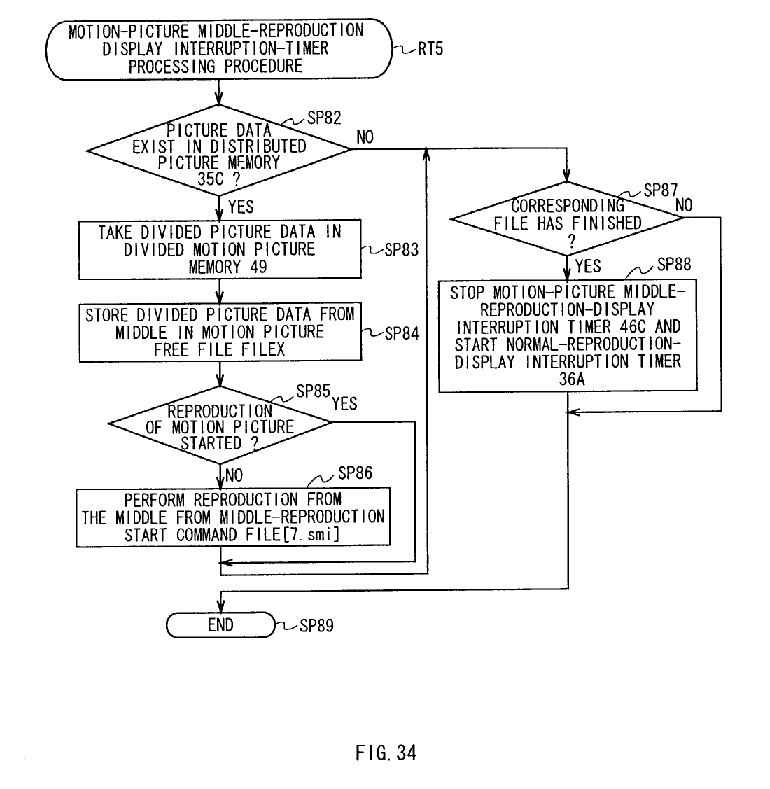

In the case of watching the motion picture from the middle, on the contrary, the CPU 31 can perform the reproduction and display (steps SP83, SP84, SP86 of FIG. 34), in accordance with the motion-picture middle-reproduction-display interruption-timer processing procedure RT5 (FIG. 34), by the middle-reproduction start command file [7, smi] which is created through steps SP19, SP20 of the X-channel button processing procedure RT1 (FIG. 27).

When the motion-picture normal-reproduction-display interruption-timer processing procedure RT4 (FIG. 33) and the motion-picture middle-reproduction-display interruption-timer processing procedure RT5 (FIG. 34) are completed, the CPU 31 performs the following processing in accordance with the normal-reproduction-display interruption-timer processing procedure RT3 (FIG. 32) once (step SP71 of FIG. 33, step SP88 of FIG. 34), thus even if other picture data is distributed following the motion picture data, the display processing of all pictures (html, cab, paz) can be surely continued through the normal-reproduction-display interruption-timer processing procedure RT3 (FIG. 32).

According to the fifth embodiment as described above, such an information distribution system can be realized that picture data having various pictures are simultaneously distributed from the program distribution server 4 to a plurality of user terminals 6A, 6B . . . connected to the information terminal network at the same display time.

(6) Other Embodiments

(6-1) In the aforementioned embodiment, it has dealt with the case where frame-contents-of-program data Dmnp composing unit program data DM-N is created through division at a fixed interval. This interval for the division, however, may not be fixed. The divided length may be unevenly determined according to the amount of data depending on the picture pattern or the kind (still picture, motion picture, etc.) of the frame contents of program.

(6-2) In the embodiment of FIG. 19, “three near an additional distribution server” are employed for assigning the user terminals (6AA, 6AB, 6AC), (6BA, 6BB, 6BC) . . . (6EA, 6EB, 6EC) to the additional distribution servers 2A, 2B . . . 2E, in order to receive program information data. However, the user terminals are assigned under a condition other than neighbors (for instance, depending on the control area of transmission line). In addition, three or more or less of user terminals may be assigned depending on the transmission rate of the transmission line.

(6-3) According to the aforementioned embodiments, the same program information can be simultaneously distributed to plural user terminals that have sent the distribution request to a program control server. In addition to this function, such function may be provided that the user terminals receiving the distribution of the same program information can update their information with each other in a chat mode. This configuration can realize such a function that the users who are watching the same picture of the program information can exchange their opinions using their screens displaying the program information.

(6-4) In the timetable data TMDAT of FIG. 5, as to each frame information specification data FRDAT, the same server has been specified by the display URLs (that is, one program distribution server 2). Instead of this, however, even if display URLs specifies different servers as the occasion demands, the same effect as the aforementioned case can be obtained.

According to the present invention as described above, the program control server distributes the channel table data for specifying unit program data, and the timetable data for specifying frame-contents-of-program data as a part of the channel table data, to the user terminals, and then the user terminal takes the corresponding frame-contents-of-program from the program distribution server based on the timetable data included in the channel table data, thus making it possible to easily and simply construct an information distribution system capable of simultaneously distributing program information data to many user terminals.

In addition, after distributing program information data stored in the main program distribution server to additional distribution servers, the user terminals which belong to each additional distribution server receive the program information data, which can realize an information distribution system capable of surely distributing program information data by seizing and controlling the traffic of the information transmission line even the program information data is a large amount of data.

(6-5) The display screen 38A of the display 38 has been described with reference to FIG. 26. In stead of this, however, as shown in FIG. 35, a program display section DP1 may be arranged in the center of the display screen 38A as a large screen, and the channel selection switch section DP2 and other various function switches DP3-DP7 may be arranged on the right side of the section DP1.

The arrangement of FIG. 35 allows the user to watch the program displayed on the program display section DP1 which is a large screen.

In addition, instead of the arrangement of FIG. 26, as shown in FIG. 36, a program display section DP1 is arranged as a small screen and a channel selection switch DP8 (having the same selection operation functions as the channel selection switch DP2 of FIG. 35) composed of an arrow key and a function selection switch DP9 (having the same selection operation functions as the switches DP3-DP7 of FIG. 35) composed of a switch key are arranged beside the program display section DP1, and thereby the display screen 38A may be used as a screen for operating the computer.

According to the arrangement of FIG. 36, the user can operate the computer while watching the program on the program display section DP1, thus making it possible to use the display screen 38A for multipurpose.

### INDUSTRIAL APPLICABILITY

The present invention can be applied to an information distribution system for distributing information to many user terminals from a distribution center via an information transmission network such as the Internet.

1. An information distribution system for distributing program information data stored in a database of a program distribution server, to many user terminals via an information transmission network under the control of a program control server, wherein:
said program information data stored in said database is composed of plural unit program data obtained by dividing the program information data on one or plural channels on a first split time basis, and each said unit program data is composed of a series of frame-contents-of-program data which is obtained by subdividing program information data for each first split time on a second split time basis; and
said program control server distributes channel table data for specifying said unit program data, and timetable data for specifying said frame-contents-of-program data as a part of said channel table data, to said user terminals, and when specification information specifying one of said channel table data has been entered with one or a plurality of said user terminals, said timetable data corresponding to the channel table data specified by input is given from said user terminals to said program distribution server, so that said corresponding frame-contents-of-program data is distributed from said program distribution server to said user terminals with which said specification information has been entered, via said information transmission network.

2. The information distribution system according to claim 1, wherein:
first split time data indicating said first split time is employed for said unit program data, and second split time data indicating second split time is employed for said frame-contents-of-program data;
said program control server distributes standard time information to match time with said user terminals, and distributes said timetable data corresponding to said channel table data to said user terminals; and
a plurality of said user terminals gives said common timetable data to said program distribution server, so as to simultaneously obtain said frame-contents-of-program data specified by said timetable data, from said program distribution server.

3. The information distribution system according to claim 1 or 2, wherein
said frame-contents-of-program data includes commercial display data as a part thereof, and thereby said user terminals display a commercial frame picture between frame pictures of the program.

4. The information distribution system according to claim 1 or 2, wherein;
said timetable data includes commercial link data as a part of commercial frame picture specification data, and said user terminal stores said commercial link data while displaying a first commercial frame picture distributed from said program distribution server based on said commercial picture specification data, on a display, and after the program finishes, said user terminal obtains a second commercial frame picture from a commercial server with said stored commercial link data and displays it on the display.

5. An information distribution system for distributing program information data stored in a database of a main program distribution server to plural additional distribution servers via an information transmission network under the control of a program control server, and then distributing the distributed program information data from said plural additional distribution servers to corresponding one or plural user terminals, said information distribution system wherein:
said program information data stored in said database is composed of plural unit program data obtained by dividing the program information data on one or plural channels on a first split time basis, and each said unit program data is composed of a series of frame-contents-of-program data which is obtained by subdividing program information data for each first split time on a second split time basis; and
said program control server distributes said program information data in the main program distribution server, to said plural additional distribution servers;
channel table data for specifying said unit program data, and timetable data for specifying said frame-contents-of-program data as a part of said channel table data are distributed from said program control server to said user terminals; and
when specification information specifying one of said channel table data is entered with one or a plurality of said user terminals, said program control server makes said additional distribution servers corresponding to said user terminals distribute said frame-contents-of-program data of said unit program data to said user terminals with which said specification information has been entered, via said information transmission network based on said timetable data included in the channel table data specified by input.

6. The information distribution system according to claim 5, wherein:
first split time data indicating said first split time is employed for said unit program data, and second split time data indicating said second split time is employed for said frame-contents-of-program data;
said program control server distributes standard time information to match time with said user terminals, and distributes said timetable data corresponding to said channel table data given from said user terminals, to said user terminals; and
a plurality of said user terminals gives said common timetable data to said distribution server, so as to simultaneously obtain said frame-contents-of-program data specified by said timetable data, from corresponding said additional distribution servers.

7. The information distribution system according to claim 5 or 6, wherein
said frame-contents-of-program data includes commercial display data as a part thereof, so that said user terminal displays a commercial picture between frame pictures of the program.

8. The information distribution system according to claim 5 or 6, wherein
said timetable data includes commercial link data as a part of commercial frame picture specification data, said user terminal stores said commercial link data while displaying a first commercial frame picture distributed from said program distribution server based on said commercial picture specification data, on the display, and after the program finishes, said user terminal obtains a second commercial frame picture from the commercial server based on said stored commercial link data and displays it on the display.

9. The information distribution system according to claim 1 or 5, wherein
said each user terminal comprises:
channel specifying means for specifying one channel from said channel table data;
first interruption timer means for making said program distribution server distribute said program information data including said frame-contents-of-program data having a distribution time corresponding to the operation time of said channel specifying means; and
second interruption timer means for displaying said distributed program information data on a display means.

10. The information distribution system according to claim 1 or 5, wherein
said user terminal activates one interruption timer means corresponding the picture type data of said distributed frame-contents-of-program data, out of plural interruption timer means provided for each picture type data as said second interruption timer, depending on said picture type data included in said frame-contents-of-program data distributed from said program distribution server, and then displays the frame-contents-of-program data on a display means when the one interruption timer means shows the display time of said distributed frame-contents-of-program data.

11. The information distribution system according to claim 1 or 5, wherein
said user terminal creates a motion picture free file having plural picture partial data storage sections, in memory means when the type of picture specified by picture type data included in said frame-contents-of-program data distributed from said program distribution server shows a divided motion picture, stores each picture partial data of the divided picture data distributed as said frame-contents-of-program data in the corresponding said picture partial data storage sections of said motion picture free file, and sequentially reads said picture partial data from said picture partial data storage section to display them on display means.

12. The information distribution system according to claim 1 or 5, wherein
said usr terminal creates a motion picture free file having picture partial data storage sections corresponding to picture partial data, in memory means when the picture type data specified by picture type data included in said frame-contents-of-program data distributed from said program distribution server shows a middle-reproduction divided motion picture, stores the middle picture partial data of the middle-reproduction divided picture data distributed as said frame-contents-of-program data, in middle picture partial data storage sections corresponding to said middle picture partial data, out of said all picture partial data storage sections of said motion picture free file, and sequentially reads the middle picture partial data from said middle picture partial data storage section to display them on display means.
